(19) United States
(12) Patent Application Publication
(10) Pub. No.: US 2015/0324773 A1
(43) Pub. Date: Nov. 12, 2015

(54) SETTLEMENT SYSTEM, USER TERMINAL DEVICE, SALES SERVER, SETTLEMENT SERVER AND RECORDING MEDIUM

(71) Applicant: NINTENDO CO., LTD., Kyoto (JP)

(72) Inventors: Hiroyuki TAKEUCHI, Kyoto (JP); Ryuichi YOSHIDA, Kyoto (JP); Atsushi SUGAWARA, Kyoto (JP); Naoki TAKEDA, Kyoto (JP); Kazuma KITAMURA, Kyoto (JP); Shinya OGURA, Kyoto (JP)

(21) Appl. No.: 14/702,987

(22) Filed: May 4, 2015

(30) Foreign Application Priority Data
May 8, 2014 (JP) 2014-097088

(51) Int. Cl. G06Q 20/12; G06Q 20/38

(52) U.S. Cl. CPC G06Q 20/12; G06Q 20/3825

(57) ABSTRACT

An example system includes: a sales server for performing sales processing pertaining to sales of a commodity; a settlement server for performing settlement processing pertaining to a commodity sold by the sales server in the sales processing; and a user terminal device having a communication unit configured to communicate with the sales server and with the settlement server via a network and an operation acceptance unit configured to accept operation pertaining to purchase of the commodity. The user terminal device has: a settlement request relay unit configured to receive a settlement request pertaining to a commodity, for which operation pertaining to purchase has been accepted by the operation acceptance unit, from the sales server and transmit the received settlement request to the settlement server; and a settlement information relay unit configured to receive settlement information pertaining to the result of the settlement processing from the settlement server and transmit the received settlement information to the sales server.

### CROSS-REFERENCE TO RELATED APPLICATIONS

This application is based upon and claims the benefit of priority of the prior Japanese Patent Application No. 2014-097088, filed on May 8, 2014, the entire contents of which are incorporated herein by reference.

### FIELD

The technology herein relates to: a settlement system for performing settlement processing related to sales of a commodity via a network; a user terminal device; a sales server; a settlement server; and a recording medium. A commodity is, for example, an article, a digital content, service, virtual currency or the like.

### BACKGROUND AND SUMMARY

Conventionally, a system for allowing a user who utilizes a user terminal device to access a server via a network and to merchandise a commodity by transmitting and receiving information between the user terminal device and the server has become widely used. This is a system such as so-called online shopping. With such a system, various means are provided as methods for paying the price of a purchased commodity. Payment methods include, for example, a method which utilizes a credit card, a method which utilizes electronic money, bank transfer, cash on delivery, and deferred payment at a store or the like.

According to an aspect of the embodiment, a settlement system is provided with: a sales server for performing sales processing pertaining to sales of a commodity; a settlement server for performing settlement processing pertaining to a commodity which is sold by the sales server in the sales processing; a communication unit configured to communicate with the sales server and with the settlement server via a network; and a user terminal device having an operation acceptance unit configured to accept operation pertaining to purchase of the commodity, and the user terminal device has: a settlement request relay unit configured to receive a settlement request pertaining to a commodity, for which operation pertaining to purchase has been accepted by the operation acceptance unit, from the sales server and transmitting the received settlement request to the settlement server; and a settlement information relay unit configured to receive settlement information pertaining to a result of the settlement processing from the settlement server and transmit the received settlement information to the sales server.

The object and advantages of the invention will be realized and attained by means of the elements and combinations particularly pointed out in the claims. It is to be understood that both the foregoing general description and the following detailed description are exemplary and explanatory and are not restrictive of the invention.

These and other objects, features, aspects and advantages of the technology herein will become clearer through the following detailed explanation with reference to the accompanying drawings.

### BRIEF DESCRIPTION OF THE DRAWINGS

FIG. 1 shows an example non-limiting schematic diagram for outlining a settlement system according to an embodiment;

FIG. 2 shows an example non-limiting block diagram for illustrating the configuration of a user terminal device;

FIG. 3 shows an example non-limiting block diagram for illustrating the configuration of an IC card;

FIG. 4 shows an example non-limiting schematic diagram for illustrating an example of balance history information stored in a storage unit of an IC card;

FIG. 5 shows an example non-limiting block diagram for illustrating the configuration of a sales server;

FIG. 6 shows an example non-limiting schematic diagram for illustrating an example of sales history information stored in a storage unit of a sales server;

FIG. 7 shows an example non-limiting block diagram for illustrating the configuration of a first settlement server;

FIG. 8 shows an example non-limiting schematic diagram for illustrating an example of settlement history information stored in a storage unit of a first settlement server;

FIG. 9 shows an example non-limiting block diagram for illustrating the configuration of a second settlement server;

FIG. 10 shows an example non-limiting schematic diagram for illustrating an example of settlement processing to be performed by a settlement system according to an embodiment;

FIG. 11 shows an example non-limiting flowchart for illustrating procedures of settlement processing to be performed by a sales server;

FIG. 12 shows an example non-limiting flowchart for illustrating procedures of relay processing to be performed by a user terminal device;

FIG. 13 shows an example non-limiting flowchart for illustrating procedures of relay processing to be performed by a user terminal device;

FIG. 14 shows an example non-limiting flowchart for illustrating procedures of settlement processing to be performed by a first settlement server;

FIG. 15 shows an example non-limiting flowchart for illustrating procedures of settlement processing to be performed by a first settlement server;

FIG. 16 shows an example non-limiting flowchart for illustrating procedures of settlement processing to be performed by a second settlement server;

FIG. 17 shows an example non-limiting flowchart for illustrating procedures of settlement processing to be performed by a second settlement server;

FIG. 18 shows an example non-limiting schematic diagram for illustrating an example of malfunction confirmation processing of a settlement system according to an embodiment;

FIG. 19 shows an example non-limiting flowchart for illustrating procedures of restoration processing to be performed by a sales server;

FIG. 20 shows an example non-limiting flowchart for illustrating procedures of restoration processing to be performed by a sales server;

FIG. 21 shows an example non-limiting flowchart for illustrating procedures of malfunction determination processing to be performed by a first settlement server; and

FIG. 22 shows an example non-limiting flowchart for illustrating procedures of history inquiry processing to be performed by a second settlement server.

### DETAILED DESCRIPTION OF NON-LIMITING EXAMPLE EMBODIMENTS

### System Outline

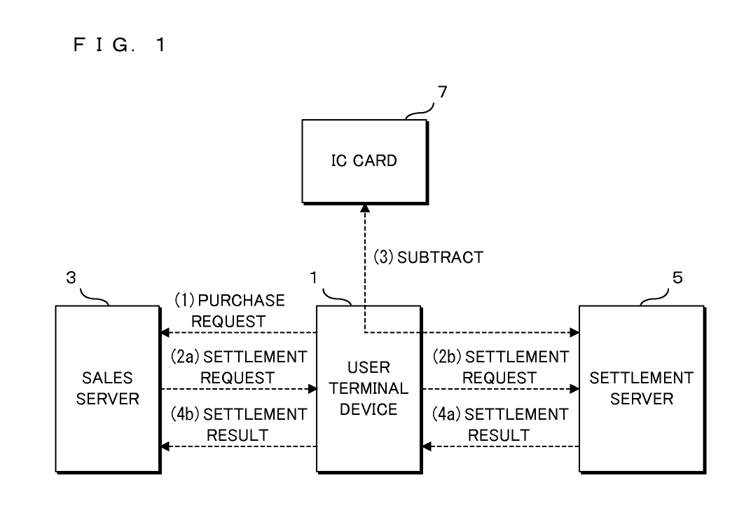

FIG. 1 shows an example non-limiting schematic diagram for outlining a settlement system according to the present embodiment. A settlement system according to the present embodiment includes a user terminal device 1, a sales server 3 and a settlement server 5. The user terminal device 1 is a device to be utilized by a user for purchase of a commodity. The user terminal device 1 is a device such as a game machine, a personal computer, a portable telephone, a smartphone or a tablet-type terminal, for example. The user terminal device 1 can communicate respectively with the sales server 3 and with the settlement server 5 via a wired or wireless network. The user terminal device 1 can communicate with an IC card 7 using a non-contact communication function.

A settlement system according to the present embodiment is a so-called online sales system with which the sales server 3 sells a commodity via a network and the user purchases a commodity utilizing the user terminal device 1. A settlement system according to the present embodiment is a system with which a purchaser (consumer) purchases an article, service or the like via a network such as the Internet utilizing the user terminal device 1 without meeting a seller face to face. The user terminal device 1 is not a device to be installed in a store but is a non-face-to-face device. The user terminal device 1 is not a device to be operated by a seller of a commodity but is a device to be operated by a purchaser of a commodity.

A commodity to be sold by the sales server 3 may be an article to be delivered later to the user's home or the like by mail or the like, for example. As another example, a commodity to be sold may be some kind of service to be provided to the user or the like who purchases the commodity. As yet another example, a commodity to be sold may be a digital content to be downloaded to the user terminal device 1 as a result of purchase. Furthermore, a commodity may be various other things.

When a commodity to be sold by the sales server 3 is a digital content, the user terminal device 1 can download and utilize a purchased digital content. Examples of a digital content are a video work such as a movie or a television broadcast, a game, an application, a database, a web site, program software, text data, a comic book, music, an animation, a picture, art, a computer graphic, a character and the like. For example, when a video work is purchased as a digital content, the user terminal device 1 can perform processing to download moving picture data of the video work from the sales server 3, another server or the like, reproduce the moving picture data, and display the data at a display unit or the like. A digital content such as a video work or music may be provided by so-called streaming distribution. As another example, when a game is purchased as a digital content, the user terminal device 1 can download and execute a program of the game, data and the like. The user terminal device 1 can perform processing for utilizing a purchased digital content.

As another example, a commodity to be sold by the sales server 3 may be virtual currency. Virtual currency incudes, for example, points which can be utilized for purchasing a commodity at a specific web site, points which can be utilized for purchasing an item, an additional scenario or the like in a specific game, or the like. The user terminal device 1 can preliminarily purchase virtual currency at the sales server 3 and purchase a commodity using the virtual currency in a specific web site or game.

With a settlement system according to the present embodiment, a user who purchases a commodity can utilize the IC card 7 for payment of a price. The user can preliminarily charge electronic money, points or the like, which can be used for purchase of a commodity, in the IC card 7 at, for example, a store or the like. The IC card 7 stores the balance of charged electronic money, points or the like in an inner memory. The IC card 7 has a non-contact communication function, and can perform settlement processing with the settlement server 5 via the user terminal device 1.

A user who utilizes online sales operates first the user terminal device 1 so as to access the sales server 3 and perform log-in processing to the present system. When log-in succeeds, the sales server 3 transmits information such as a list of commodities being sold to the user terminal device 1. The user terminal device 1 displays the list of purchasable commodities at the display unit. The user operates the user terminal device 1 so as to select a commodity to be purchased and give a purchase request to the sales server 3 (see (1) in the figure). When the purchase request from the user terminal device 1 is given, the sales server 3 calculates the total amount or the like of commodities to be purchased. The sales server 3 transmits a request for payment of the amount to the user terminal device 1 as a settlement request (see (2a) in the figure). When receiving the settlement request from the sales server 3, the user terminal device 1 transmits the received settlement request to the settlement server 5 (see (2b) in the figure).

When receiving a settlement request from the user terminal device 1, the settlement server 5 communicates with the IC card 7, which is owned by the user, via the user terminal device 1. The settlement server 5 performs processing to subtract the amount corresponding to the commodity price from the balance stored in the IC card 7 (see (3) in the figure). At this time, the user terminal device 1 displays, for example, a message or the like to prompt the user to bring the IC card 7 to be used for payment into contact with a predetermined location of the user terminal device 1 at the display unit, and performs non-contact communication with the IC card 7. The user terminal device 1 transmits information, which is received from the settlement server 5, to the IC card 7 and also transmits information, which is received from the IC card 7, to the settlement server 5. Communication between the settlement server 5 and the IC card 7 via the user terminal device 1 is performed a plurality of times, and the commodity price is therefore subtracted from the balance in the IC card 7.

After finishing communication with the IC card 7, the settlement server 5 transmits the result of settlement processing to the user terminal device 1 (see (4a) in the figure). When the commodity price can be subtracted from the balance in the IC card 7, a result that settlement processing has been succeeded is transmitted. In contrast, when the commodity price cannot be subtracted due to a factor such that the balance is insufficient or a malfunction has occurred in communication, a result that settlement processing has failed is transmitted. When receiving a settlement result from the settlement server 5, the user terminal device 1 transmits the received settlement result to the sales server 3 (see (4b) in the figure). The sales server 3 performs sales processing of a commodity on the basis of the settlement result received from the user terminal device 1. When settlement processing has been succeeded, for example, the sales server 3 judges that the price of a commodity to be sold has been paid, and advances the sales processing to a step such as preparation for sending a commodity or permission of downloading. When settlement processing has failed, for example, the sales server 3 notifies the user terminal device 1 of a fact that settlement processing has failed, a fact that settlement processing is to be performed again, or the like.

In a settlement system according to the present embodiment, the sales server 3 and the settlement server 5 do not communicate directly with each other but communicate via the user terminal device 1. As a result, smooth settlement processing can be implemented without the possibility of failure in settlement processing due to a communication malfunction or the like between the sales server 3 and the settlement server 5.

In a settlement system according to the present embodiment, information included in a settlement request transmitted by the sales server 3 is encrypted. The settlement request cannot be decrypted or altered by the user terminal device 1 but can be decrypted by the settlement server 5. Similarly, a settlement result transmitted from the settlement server 5 is encrypted. The settlement result cannot be decrypted or altered by the user terminal device 1 but can be decrypted by the sales server 3. Such encryption can enhance the reliability of the settlement system.

Although a settlement system according to the present embodiment is constructed to encrypt a settlement request and a settlement result before transmission and reception as described above, the technology herein is not limited to this. For example, the sales server 3 may transmit a settlement request with an electronic signature attached thereto. The settlement server 5 may be constructed to confirm whether an electronic signature is valid or not when receiving the settlement request via the user terminal device 1. In such a case, the settlement server 5 may transmit a settlement result with an electronic signature attached thereto. The sales server 3 may be constructed to confirm whether an electronic signature is valid or not when receiving the settlement result via the user terminal device 1.

### <Device Configuration>

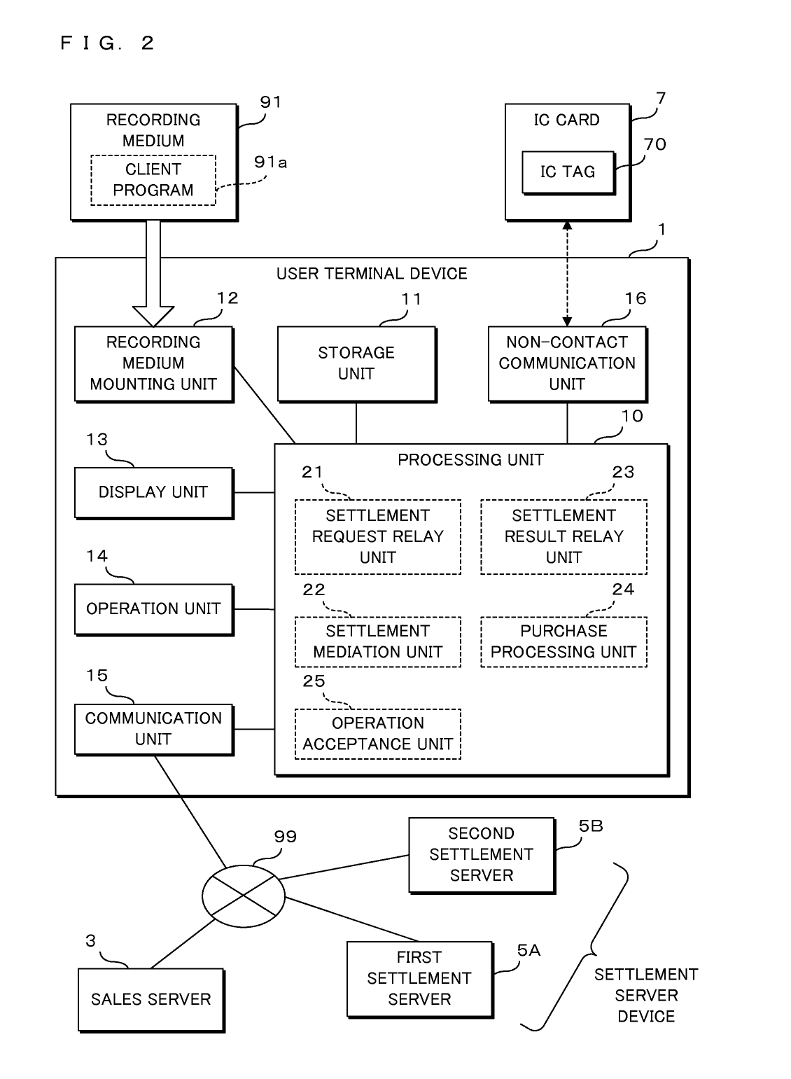

FIG. 2 shows an example non-limiting block diagram for illustrating the configuration of the user terminal device 1. The user terminal device 1 according to the present embodiment is provided with a processing unit 10, a storage unit 11, a recording medium mounting unit 12, a display unit 13, an operation unit 14, a communication unit 15, a non-contact communication unit 16 and the like. The processing unit 10 of the user terminal device 1 is constituted of an arithmetic processing device such as a CPU (Central Processing Unit). The processing unit 10 performs various information processing pertaining to purchase of a commodity, settlement and the like by reading and executing a client program 91a recorded in a recording medium 91 which is mounted on the recording medium mounting unit 12. It is to be noted that the client program 91a read from the recording medium 91 may be preliminarily stored in the storage unit 11, and the processing unit 10 may be constructed to read the client program 91a from the storage unit 11.

The storage unit 11 is constituted of a volatile or nonvolatile semiconductor memory device, a hard disk drive or the like. The storage unit 11 stores various programs such as the client program 91a and data to be used for execution of the programs. The storage unit 11 can preliminarily store a digital content purchased at the sales server 3. The recording medium mounting unit 12 is constructed in a manner such that a recording medium 91 of card type, cassette-type, disk type or the like can be mounted detachably. The processing unit 10 can read the client program 91a and various data from the recording medium 91 mounted on the recording medium mounting unit 12. The processing unit 10 may be constructed to be able to write a program, data or the like in the recording medium 91.

The display unit 13 is constituted of a liquid crystal panel or the like, and displays an image given from the processing unit 10. The operation unit 14 is, for example, a depression-type button, a touch panel provided at the display unit 13, or the like. The operation unit 14 gives a signal corresponding to the content of operation by the user (e.g., button depression, release or the like) to the processing unit 10. The communication unit 15 transmits and receives information to and from the sales server 3, the settlement server 5, another server, another user terminal device 1 or the like via a network 99 such as the Internet, for example. The user terminal device 1 can, for example, communicate with a server at the communication unit 15 so as to download the client program 91a or the like, and store the client program 91a or the like in the storage unit 11.

It is to be noted that the settlement server 5 in the present embodiment is composed of a first settlement server 5A and a second settlement server 5B. The user terminal device 1 communicates with the first settlement server 5A via the network 99 but does not communicate with the second settlement server 5B.

The non-contact communication unit 16 transmits and receives data wirelessly and contactlessly to and from the IC card 7 or the like according to, for example, the ISO/IEC18092 (so-called NFC) communication standard or the like. The communication range of the non-contact communication unit 16 is typically between approximately several millimeters and several centimeters. The non-contact communication unit 16 transmits a signal, which indicates reading of stored data, to an IC tag 70 built in the IC card 7, and receives desired data as a response to the signal. The non-contact communication unit 16 has a function of a so-called reader for a IC tag. Moreover, the non-contact communication unit 16 can cause the IC tag 70 to write data by transmitting write data and a signal which indicates writing. That is, the non-contact communication unit 16 has a function of a writer for an IC tag. Here, the communication mode used by the non-contact communication unit 16 is not limited to NFC but may be various communication modes such as RFID, for example, to be employed as non-contact communication, short-range wireless communication or the like.

In the user terminal device 1 according to the present embodiment, the processing unit 10 executes the client program 91a so as to implement a settlement request relay unit 21, a settlement mediation unit 22, a settlement result relay unit 23, a purchase processing unit 24, an operation acceptance unit 25 and the like as software functional blocks. The settlement request relay unit 21 performs processing to transmit a settlement request, which has been received at the communication unit 15 from the sales server 3, from the communication unit 15 to the first settlement server 5A. The settlement mediation unit 22 performs processing to mediate settlement processing, which is performed between the first settlement server 5A and the IC card 7, through communication at the communication unit 15 with the first settlement server 5A and non-contact communication at the non-contact communication unit 16 with the IC card 7. The settlement result relay unit 23 performs processing to transmit a settlement result, which has been received at the communication unit 15 from the first settlement server 5A, from the communication unit 15 to the sales server 3. The purchase processing unit 24 communicates with the sales server 3 at the communication unit 15, and performs processing pertaining to commodity purchase. Processing pertaining to commodity purchase is, for example, processing to display a list of purchasable commodities at the display unit 13, processing to accept selection of a commodity to be purchased, processing to transmit a purchase request of a selected commodity from the communication unit 15 to the sales server 3, and the like. The operation acceptance unit 25 performs processing to accept operation by the user on the basis of an input signal from the operation unit 14. The processing unit 10 can perform various processing on the basis of user operation to the operation unit 14 accepted by the operation acceptance unit 25.

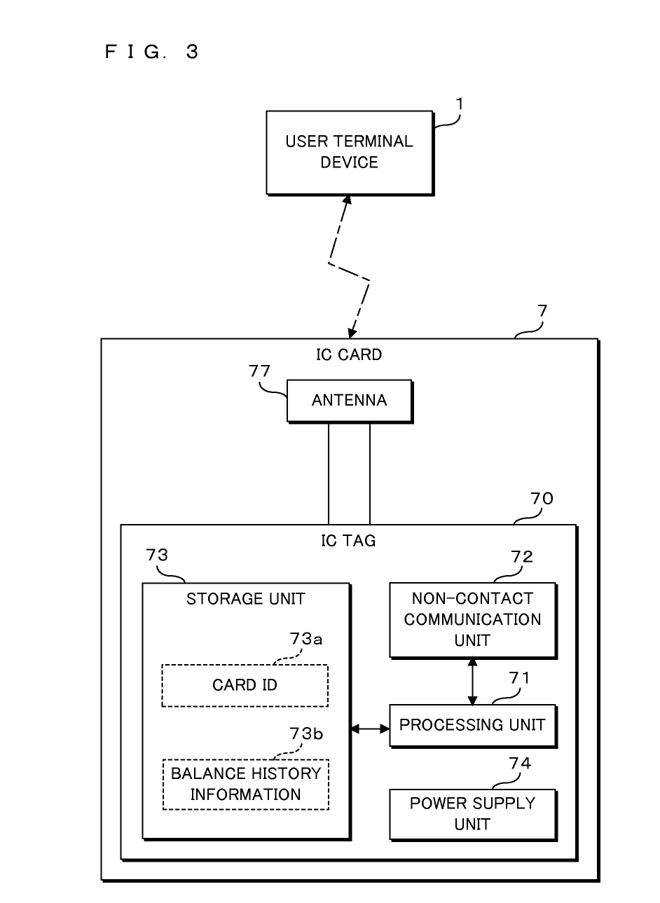

FIG. 3 shows an example non-limiting block diagram for illustrating the configuration of the IC card 7. The IC card 7 according to the present embodiment is a storage medium constructed by burying the IC tag 70 and an antenna 77 in a card body made by, for example, synthetic resin, paper or the like. The IC card 7 stores information related to the balance of electronic money, points or the like. The IC card 7 is used for payment of a commodity price in online sales or the like. The antenna 77 of the IC card 7 can be constructed by, for example, disposing metal wire spirally in the IC card 7 and connecting both ends of the metal wire with the IC tag 70. The IC tag 70 is provided as one IC chip. The IC tag 70 has a processing unit 71, a non-contact communication unit 72, a storage unit 73, a power supply unit 74 and the like.

The IC tag 70 does not have a power source such as a battery. The IC tag 70 is operated by electromotive force which is generated by electromagnetic induction or the like when a radio signal from the user terminal device 1 is received at the antenna 77. The IC tag 70 is a so-called passive-type tag. The power supply unit 74 supplies electric power to the processing unit 71, the non-contact communication unit 72, the storage unit 73 and the like in the IC tag 70. The respective units are operated by electric power supplied from the power supply unit 74. Although the passive-type IC tag 70 is employed in the present embodiment, it is to be noted that an active-type tag may be employed.

The non-contact communication unit 72 of the IC tag 70 receives a signal, which has been transmitted from the user terminal device 1, at the antenna 77, and gives data pertaining to the received signal to the processing unit 71. The non-contact communication unit 72 transmits data, which has been given from the processing unit 71, from the antenna 77 to the user terminal device 1. The storage unit 73 is constituted of a data-rewritable volatile or nonvolatile memory device. The storage unit 73 stores a card ID (IDentifier) 73a attached individually to each IC tag 70, balance history information 73b, which is change history of the balance such as electronic money or points, and the like. The processing unit 71 reads data from the storage unit 73 in accordance with data given from the non-contact communication unit 72, and gives the read data to the non-contact communication unit 72 so as to transmit the data to the user terminal device 1. The processing unit 71 writes data in the storage unit 73 in accordance with data given from the non-contact communication unit 72.

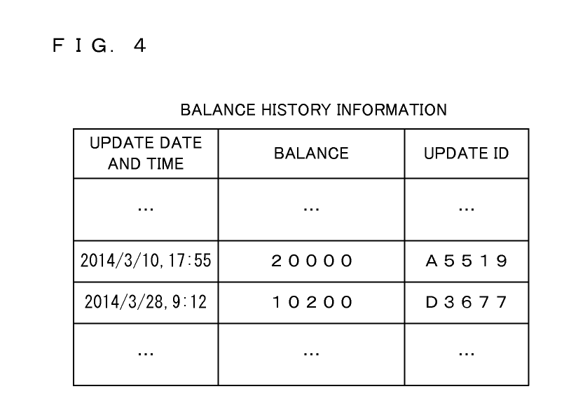

FIG. 4 shows an example non-limiting schematic diagram for illustrating an example of the balance history information 73b stored in the storage unit 73 of the IC card 7. In the balance history information 73b of this example, update date and time, the balance and an update ID are stored in association with each other. Update date and time is date and time when the balance in the IC card 7 is updated. The balance is the amount of electronic money, points or the like charged in the IC card 7 at the point of updating. An update ID is identification information related to update processing of the balance in the IC card 7. The update ID is given from the second settlement server 5B. The number of balance history which can be stored in the storage unit 73 is set in accordance with the memory capacity of the storage unit 73 as, for example, 10, 100 or the like. When the number of times of updating exceeds the number of balance history which can be stored, information on updating corresponding to older update date and time is deleted, and information on new updating is added. The history stored in the balance history information 73b may be a value of the remaining amount itself, or may be a change (i.e., an increase/decrease value) in the amount.

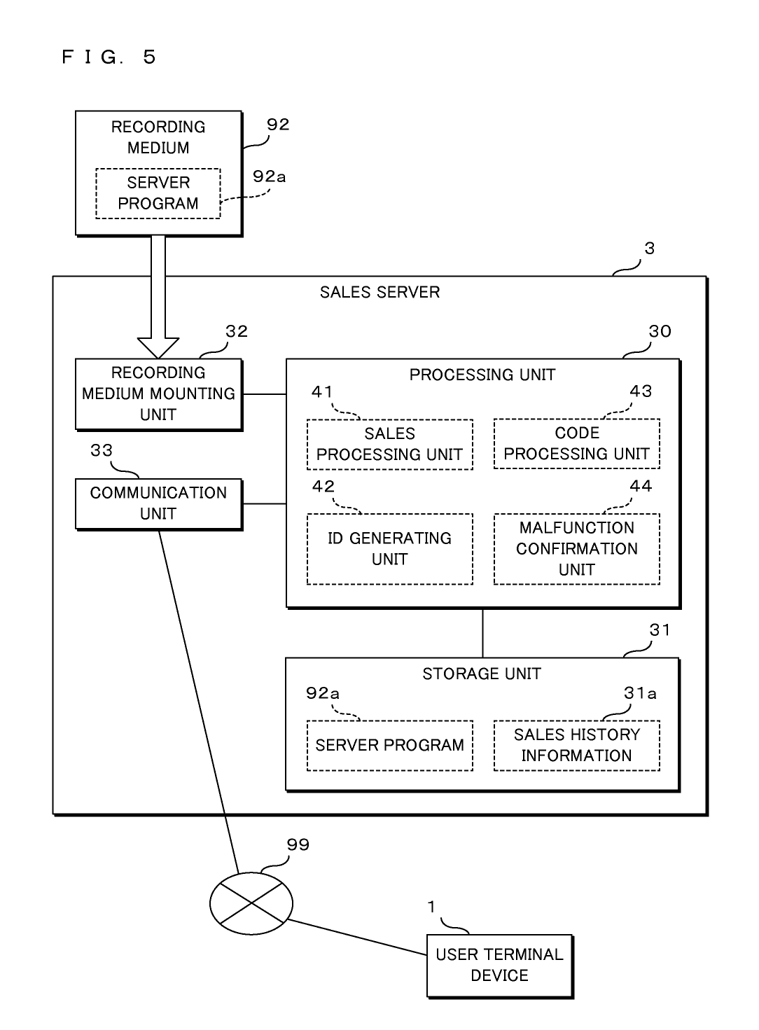

FIG. 5 shows an example non-limiting block diagram for illustrating the configuration of the sales server 3. The sales server 3 according to the present embodiment is provided with a processing unit 30, a storage unit 31, a recording medium mounting unit 32, a communication unit 33 and the like. The processing unit 30 is constituted of an arithmetic processing device such as a CPU. The processing unit 30 performs various processing pertaining to sales of a commodity by reading and executing a server program 92a stored in the storage unit 31. The storage unit 31 is constituted of a nonvolatile storage device. The storage unit 31 can store programs such as the server program 92a and various data. The storage unit 31 in the present embodiment stores history pertaining to sales processing of a commodity as sales history information 31a.

The recording medium mounting unit 32 is constructed in a manner such that a recording medium 92 having a disk shape or the like can be mounted detachably. The processing unit 30 can read a server program 92a and various other data from the recording medium 92 mounted on the recording medium mounting unit 32, and install the server program 92a and various other data in the storage unit 31. The communication unit 33 transmits and receives data to and from the user terminal device 1 via the network 99 such as the Internet. It is to be noted that the sales server 3 in the present embodiment does not communicate with the first settlement server 5A or the second settlement server 5B.

In the sales server 3 according to the present embodiment, the processing unit 30 executes the server program 92a so as to implement a sales processing unit 41, an ID generating unit 42, a code processing unit 43, a malfunction confirmation unit 44 and the like as software functional blocks. The sales processing unit 41 performs processing to transmit information such as a list of commodities being sold, for example, to the user terminal device 1. The sales processing unit 41 performs processing to accept, for example, a purchase request of a commodity from the user terminal device 1. The sales processing unit 41 performs processing to transmit a settlement request pertaining to the requested commodity, for example, to the user terminal device 1. The sales processing unit 41 performs processing to receive, for example, the result of settlement processing from the user terminal device 1. The sales processing unit 41 performs processing to sales a commodity in accordance with, for example, the result of settlement processing. The sales processing unit 41 may perform other processing.

When accepting a purchase request from the user terminal device 1, the ID generating unit 42 generates identification information for a series of processing such as sales processing and settlement processing related to a commodity for which purchase has been requested. The identification information in the present embodiment is referred to as a transaction ID. For example, the ID generating unit 42 may generate a random numerical value as a transaction ID. As another example, the ID generating unit 42 may generate a serial number as a transaction ID. The ID generating unit 42 may generate a transaction ID by another method. A transaction ID generated by the ID generating unit 42 is related to a settlement request to be transmitted from the sales processing unit 41 to the user terminal device 1. The sales server 3 manages the progress status or the like of sales processing of a commodity utilizing the transaction ID.

For transmitting a settlement request to the user terminal device 1, the code processing unit 43 performs processing to encrypt information included in the settlement request. The settlement request can include, for example, information such as the transaction ID described above, date and time information of a settlement request, amount information of a purchased commodity, or an electronic signature. The sales processing unit 41 transmits a settlement request, which is encrypted by the code processing unit 43, to the user terminal device 1. It is to be noted that the encrypted settlement request cannot be decoded or altered by the user terminal device 1. The settlement request can be decoded by the first settlement server 5A. Moreover, the settlement result received from the user terminal device 1 has been encrypted similarly. The code processing unit 43 performs processing to decode the received settlement result. The code processing unit 43 encrypts and decodes information using algorithm of a public key system, for example.

The malfunction confirmation unit 44 performs processing to confirm whether a malfunction has occurred in settlement processing or not, processing to confirm the malfunction occurrence point in processing steps of settlement processing, and the like. The malfunction confirmation unit 44 performs such processing when a settlement result from the user terminal device 1 is not obtained for a predetermined time period or longer after settlement request, or when a result of Settlement Failure is given from the user terminal device 1, for example. At this time, the malfunction confirmation unit 44 makes an inquiry about the progress status of settlement processing to the user terminal device 1 with a transaction ID designated. The malfunction confirmation unit 44 confirms existence/nonexistence of occurrence of a malfunction, the occurrence point and the like on the basis of a response to the inquiry. The malfunction confirmation unit 44 performs processing to restart settlement processing, sales processing or the like which has been in a stopped state after a malfunction occurs.

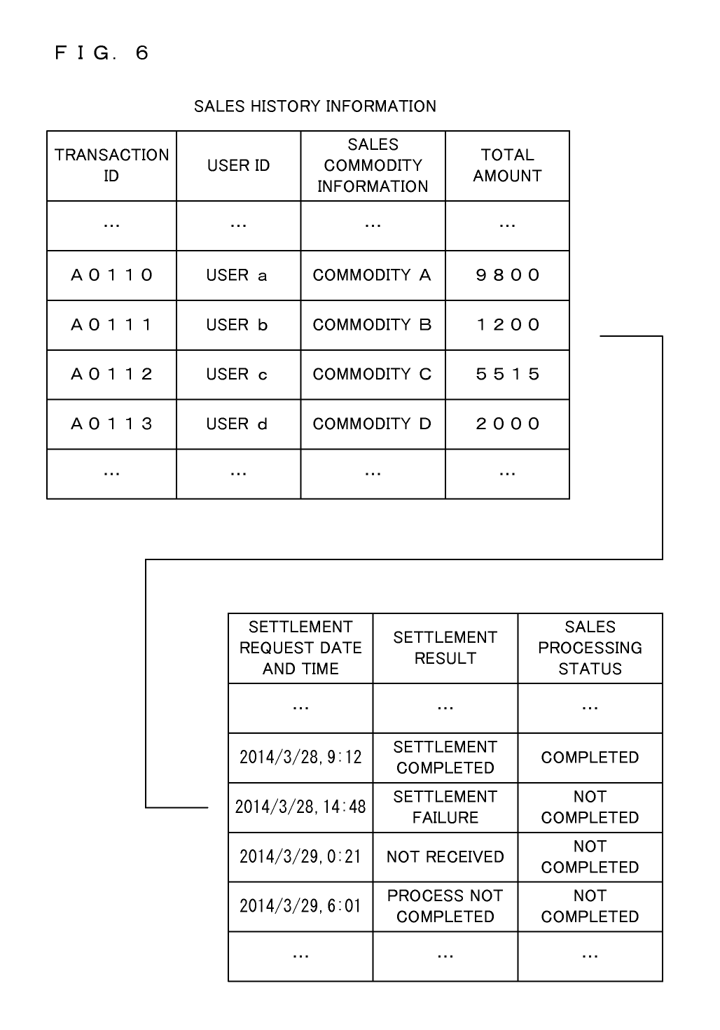

FIG. 6 shows an example non-limiting schematic diagram for illustrating an example of the sales history information 31a stored in the storage unit 31 of the sales server 3. In the sales history information 31a, information such as a user ID, sales commodity information, the total amount, settlement request date and time, the settlement result and the sales processing status is stored in association with a transaction ID. A user ID is identification information to be related to a user who purchases a commodity utilizing the user terminal device 1. For performing log-in processing to the present system, the user enters his user ID at the user terminal device 1. Sales commodity information is information related to a sold commodity (for which purchase has been requested by the user). Sales commodity information includes, for example, information such as a commodity name or a commodity number, and information such as the number or amount of sold commodities. The total amount is numerical value information indicating the total amount of sold commodities. Settlement request date and time is date and time when a settlement request related to the transaction ID is transmitted to the user terminal device 1. The settlement result is information indicating the result of settlement which has been received from the user terminal device 1 to the settlement request. The settlement result is any one of Settlement Completed, Settlement Failure, Process Not Completed, and Not Received. Settlement Completed is a state where it has been confirmed that settlement processing by the settlement server 5 has been terminated normally. Settlement Failure is a state where it has been confirmed that settlement processing has not been terminated normally due to, for example, insufficient balance in the IC card 7 or the like. Process Not Completed is a state where whether writing of information in the IC card 7 has been terminated normally or not is unclear. Not Received is a state where a settlement result from the user terminal device 1 has not been received. A sales processing status is a flag indicating whether sales processing of a commodity related to the transaction ID has been completed or not. The structure of the sales history information 31a illustrated in FIG. 6 is an example, and the technology herein is not limited to the structure.

In a settlement system according to the present embodiment, the settlement server 5 is composed of two devices of the first settlement server 5A and the second settlement server 5B as described above. The first settlement server 5A performs processing to communicate with the settlement server 3 via the user terminal device 1, processing to store history information related to settlement processing, and the like in settlement processing performed by the settlement server 5 illustrated in FIG. 1. The second settlement server 5B performs processing to subtract the price of a commodity from the IC card 7, or the like.

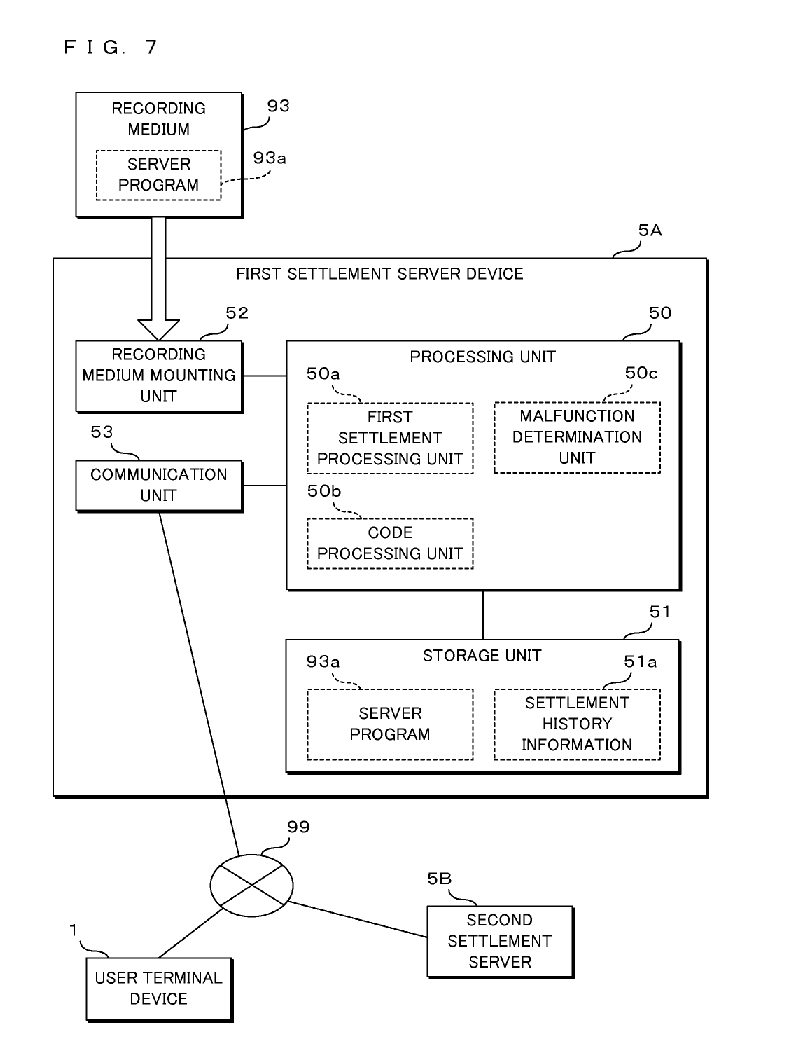

FIG. 7 shows an example non-limiting block diagram for illustrating the configuration of the first settlement server 5A. The first settlement server 5A according to the present embodiment is provided with a processing unit 50, a storage unit 51, a recording medium mounting unit 52, a communication unit 53 and the like. The processing unit 50 is constituted of an arithmetic processing device such as a CPU. The processing unit 50 performs the processing described above pertaining to settlement by reading and executing a server program 93a stored in the storage unit 51. The storage unit 51 is constituted of a nonvolatile storage device, and can store programs such as the server program 93a and various data. The storage unit 51 in the present embodiment stores history pertaining to settlement processing as settlement history information 51a.

The recording medium mounting unit 52 is constructed in a manner such that a recording medium 93 having a disk shape or the like can be mounted detachably. The processing unit 50 can read a server program 93a and various other data from the recording medium 93 mounted on the recording medium mounting unit 52, and install the server program 93a and various other data in the storage unit 51. The communication unit 53 transmits and receives data to and from the user terminal device 1 and the second settlement server 5B via the network 99 such as the Internet. It is to be noted that the first settlement server 5A in the present embodiment does not communicate with the settlement server 3.

In the first settlement server 5A according to the present embodiment, the processing unit 50 executes the server program 93a so as to implement a first settlement processing unit 50a, a code processing unit 50b, a malfunction determination unit 50c and the like as software functional blocks. The code processing unit 50b performs processing to decode a settlement request, which has been received at the communication unit 53 from the user terminal device 1. The code processing unit 50b performs processing to encrypt information included in a settlement result to be transmitted to the user terminal device 1.

The first settlement processing unit 50a performs processing to generate a settlement request of a type suitable for the second settlement server 5B on the basis of a settlement request, which has been received from the user terminal device 1 and has been decoded. The first settlement processing unit 50a performs processing to transmit the generated settlement request from the communication unit 53 to the second settlement server 5B. That is, the first settlement processing unit 50a performs processing to convert or translate a settlement request from the sales server 3 into a settlement request suitable for the second settlement server 5B. A settlement request suitable for the second settlement server 5B is, for example, a command or the like which can be interpreted at the second settlement server 5B.

The first settlement processing unit 50a converts a processing request to the IC card 7, which has been received from the second settlement server 5B, into a command to access the IC card 7, and transmits the command to the user terminal device 1. The first settlement processing unit 50a receives a response from the IC card 7 via the user terminal device 1. The first settlement processing unit 50a creates a response to a processing request from the second settlement server 5B on the basis of the response from said IC card 7, and transmits the response from the communication unit 53 to the second settlement server 5B.

The first settlement processing unit 50a performs processing to generate a settlement result suitable for the sales server 3 on the basis of the result of settlement processing, which has been received at the communication unit 53 from the second settlement server 5B. The first settlement processing unit 50a performs processing to transmit the generated settlement result from the communication unit 53 to the sales server 3. That is, the first settlement processing unit 50a performs processing to convert or translate a settlement result from the second settlement server 5B into a settlement result suitable for the sales server 3. A settlement result suitable for the sales server 3 is, for example, a command of a type which can be interpreted at the sales server 3 or the like.

As described above, the first settlement processing unit 50a performs conversion processing and transfer processing of information to be transmitted and received between the sales server 3 and the second settlement server 5B. The first settlement processing unit 50a performs conversion processing and transfer processing of information to be transmitted and received between the second settlement server 5B and the IC card 7. By providing the first settlement server 5A for performing such processing, it becomes possible to, for example, adapt easily settlement processing of the second settlement server 5B to a plurality of types of sales servers 3 having different configurations, a user terminal device 1 having a protocol or the like different from the second settlement server 5B, a plurality of types of IC cards 7, or the like. It is possible to adapt easily any one of the sales server 3 and the second settlement server 5B to a change in specifications of the other.

The first settlement processing unit 50a performs processing to store history pertaining to settlement processing in the storage unit 51 as the settlement history information 51a. The first settlement processing unit 50a stores the history of settlement processing in association with a transaction ID. When a request for malfunction confirmation of settlement processing is given from the sales server 3 or the like with a transaction ID designated, the malfunction determination unit 50c of the first settlement server 5A refers to the settlement history information 51a in the storage unit 51 and determines whether a malfunction has occurred in settlement processing or not. The malfunction determination unit 50c notifies the sales server 3 of existence/nonexistence of a malfunction, the malfunction occurrence point in processing steps of settlement processing, and the like via the user terminal device 1.

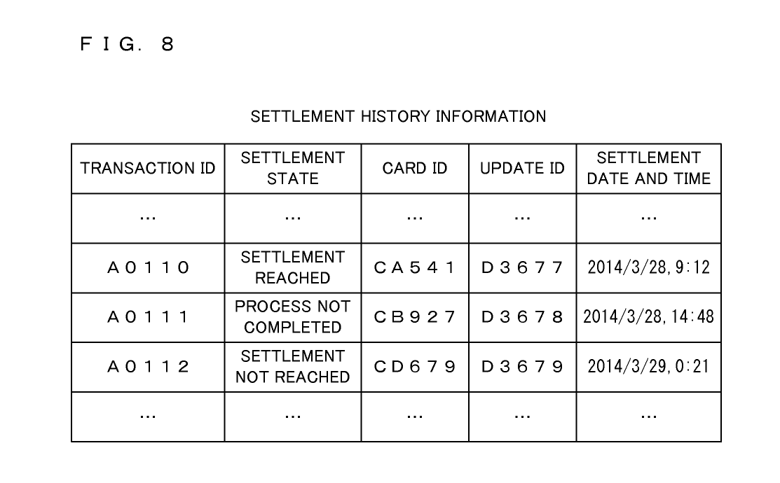

FIG. 8 shows an example non-limiting schematic diagram for illustrating an example of the settlement history information 51a stored in the storage unit 51 of the first settlement server 5A. In the settlement history information 51a, information such as a settlement state, a card ID, an update ID, and settlement date and time is stored in association with a transaction ID. A settlement state is information indicating a progress state of settlement processing. A settlement state in the present embodiment is any one of three states of Settlement Not Reached, Process Not Completed and Settlement Reached. Settlement Not Reached is a state from when a settlement request from the user terminal device 1 is received to when the user terminal device 1 starts data writing to the IC card 7. Process Not Completed is a state where data write instruction to the IC card 7 is given but a response to the instruction is not obtained and whether data has been written normally or not is unclear. Settlement Reached is a state where data writing in the IC card 7 has been terminated normally.

A card ID of the settlement history information 51a is stored in the IC card 7 utilized for settlement processing by the user. The first settlement processing unit 50a can acquire the card ID of the IC card 7 at the first time communication with the IC card 7 via the user terminal device 1. An update ID is identification information related to update processing of the balance in the IC card 7. The update ID is given from the second settlement server 5B. The update ID is also stored in the balance history information 73b of the IC card 7. Settlement date and time is date and time when settlement processing is started, and is date and time when a settlement request from the user terminal device 1 is received.

When receiving a settlement request from the sales server 3 via the user terminal device 1, the first settlement processing unit 50a of the first settlement server 5A adds information on a transaction ID, which is related to a received settlement request, to the settlement history information 51a in the storage unit 51. At this time, information to be added to the settlement history information 51a is information wherein the settlement state is Settlement Not Reached, the card ID and the update ID are unclear, and the settlement date and time is date and time of reception of a settlement request. The first settlement processing unit 50a then mediates information interchange between the second settlement server 5B and the IC card 7. When a card ID is obtained from the IC card 7, the first settlement processing unit 50a stores the card ID in the settlement history information 51a. When an update ID is obtained from the second settlement server 5B, the first settlement processing unit 50a stores the update ID in the settlement history information 51a. Furthermore, when data write instruction to the IC card 7 is given, the first settlement processing unit 50a changes the settlement state into Process Not Completed. When a response of Writing Completed is obtained from the IC card 7, the first settlement processing unit 50a changes the settlement state into Settlement Reached.

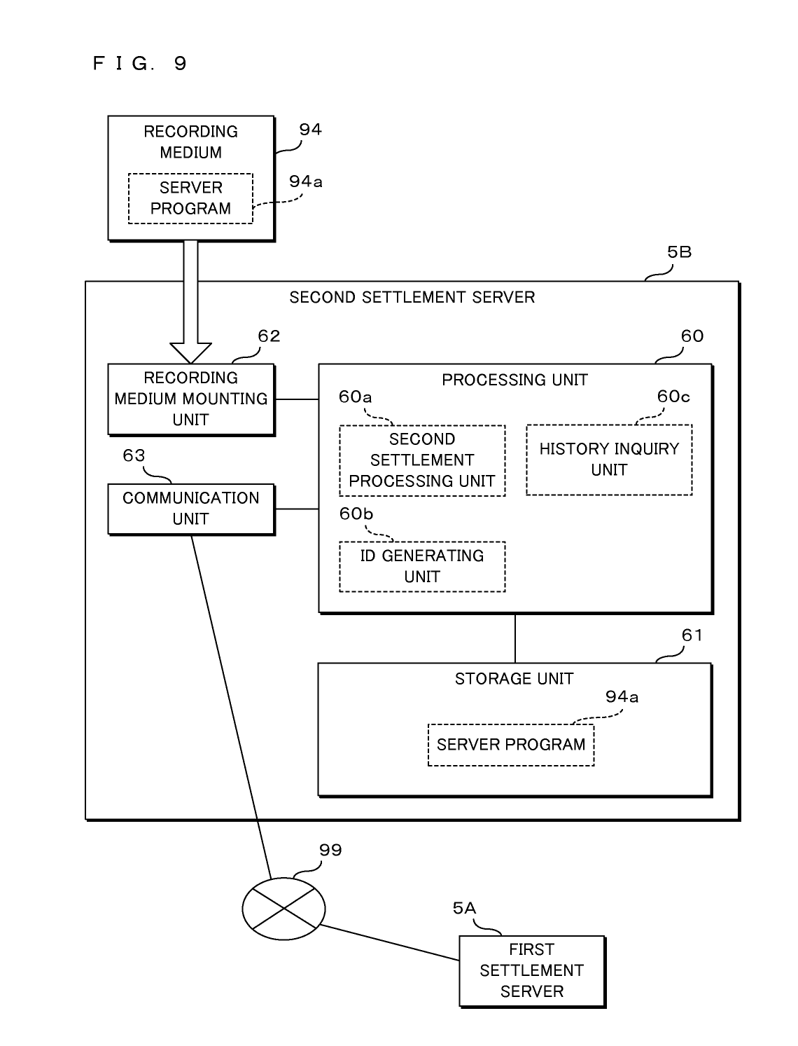

FIG. 9 shows an example non-limiting block diagram for illustrating the configuration of the second settlement server 5B. The second settlement server 5B according to the present embodiment is provided with a processing unit 60, a storage unit 61, a recording medium mounting unit 62, a communication unit 63 and the like. The processing unit 60 is constituted of an arithmetic processing device such as a CPU. The processing unit 60 performs processing pertaining to settlement by reading and executing a server program 94a stored in the storage unit 61. The storage unit 61 is constituted of a nonvolatile storage device. The storage unit 61 can store programs such as the server program 94a and various data.

The recording medium mounting unit 62 is constructed in a manner such that a recording medium 94 having a disk shape or the like can be mounted detachably. The processing unit 60 can read the server program 94a and various other data from the recording medium 94, which is mounted on the recording medium mounting unit 62, and install the server program 94a and various other data in the storage unit 61. The communication unit 63 transmits and receives data to and from the first settlement server 5A via the network 99 such as the Internet. It is to be noted that the second settlement server 5B in the present embodiment does not communicate with the user terminal device 1 or the sales server 3.

In the second settlement server 5B according to the present embodiment, the processing unit 60 executes the server program 94a so as to implement a second settlement processing unit 60a, an ID generating unit 60b, a history inquiry unit 60c and the like as software functional blocks. The second settlement processing unit 60a performs processing to subtract the commodity price from the balance in the IC card 7 on the basis of a settlement request given from the first settlement server 5A. At this time, the second settlement processing unit 60a performs information interchange several times with the IC card 7 via the first settlement server 5A and the user terminal device 1, and updates the balance in the IC card 7.

When accepting a settlement request from the first settlement server 5A, the ID generating unit 60b generates identification information for a series of settlement processing to be performed with the IC card 7. In the present embodiment, said identification information is referred to as an update ID. For example, the ID generating unit 60b may generate a random numerical value as an update ID. As another example, the ID generating unit 60b may set a serial number as an update ID. The ID generating unit 60b may generate an update ID by other methods. The update ID is stored in the balance history information 73b of the IC card 7 and in the settlement history information 51a of the first settlement server 5A.

When an inquiry request of balance history in the IC card 7 is given from the first settlement server 5A, the history inquiry unit 60c performs processing to read the balance history information 73b from the IC card 7. The history inquiry unit 60c transmits the read balance history information 73b to the first settlement server 5A. The malfunction determination unit 50c of the first settlement server 5A can determine whether a malfunction has occurred in settlement processing or not on the basis of the balance history information 73b in the IC card 7 received from the second settlement server 5B.

### <Settlement Processing>

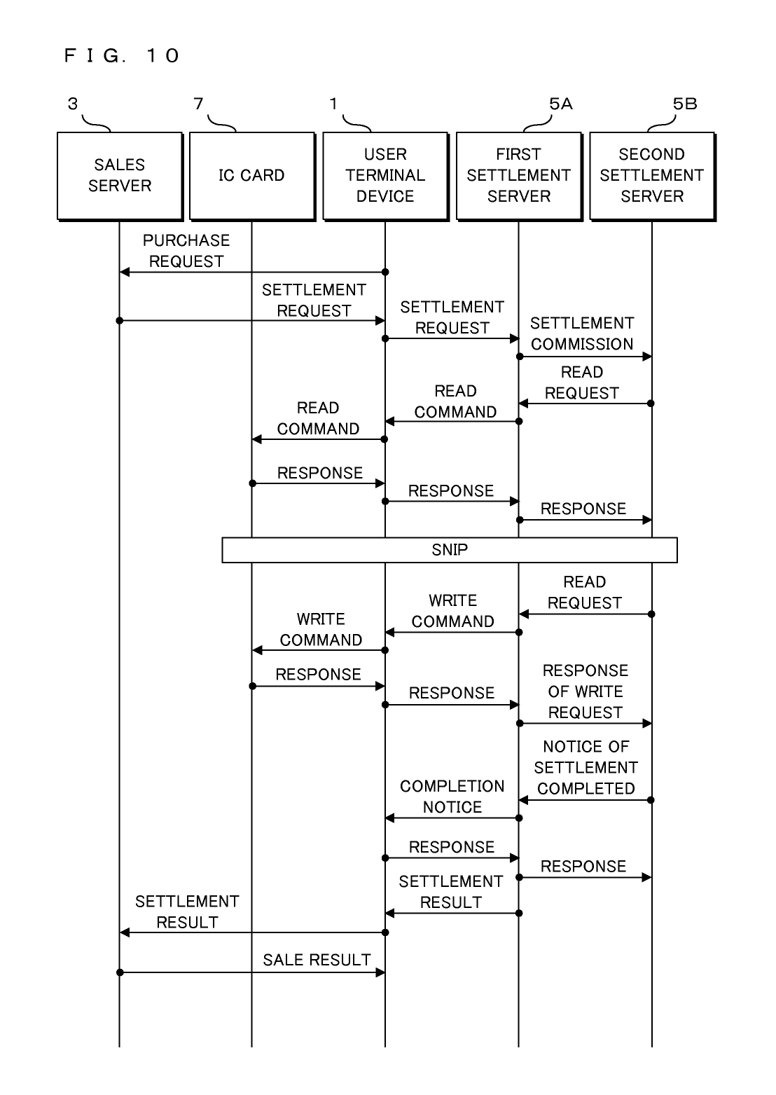

FIG. 10 shows an example non-limiting schematic diagram for illustrating an example of settlement processing to be performed by a settlement system according to the present embodiment. For example, the user can select a commodity to purchase from a list of commodities displayed at the display unit 13 of the user terminal device 1, and operate the operation unit 14 so as to make a purchase request to the sales server 3. The user terminal device 1 accepts operation by the user to the operation unit 14 at the operation acceptance unit 25. The user terminal device 1 transmits a purchase request including the ID of the user who utilizes the user terminal device 1, information for identifying a commodity to be purchased, and information, such as the number of purchased items, from the communication unit 15 to the sales server 3 in response to the accepted operation.

When receiving the purchase request from the user terminal device 1 at the communication unit 33, the sales server 3 generates a transaction ID for processing such as sales of a commodity and settlement pertaining to the received purchase request at the ID generating unit 42. The sales processing unit 41 of the sales server 3 creates a settlement request including a transaction ID, settlement date and time information, amount information of a commodity, and information such as an electronic signature. The sales processing unit 41 transmits the created settlement request from the communication unit 33 to the user terminal device 1. It is to be noted that information included in the settlement request is encrypted by the code processing unit 43. Moreover, when the sales server 3 receives a purchase request, the sales processing unit 41 of the sales server 3 adds information to the sales history information 31a in the storage unit 31. The sales processing unit 41 stores a transaction ID generated by the ID generating unit 42, a user ID generated or acquired from information included in the received purchase request, commodity information and the total amount, and date and time when a settlement request is made, in association with each other in the sales history information 31a. At this time, the settlement result of corresponding sales history information 31a is Not Received, and the sales processing status is Not Completed.

When the user terminal device 1 receives the settlement request from the sales server 3 at the communication unit 15, the settlement request relay unit 21 of the user terminal device 1 transmits the received settlement request from the communication unit 15 to the first settlement server 5A. At this time, the settlement request relay unit 21 may change information such as the header of the received settlement request, but does not change encrypted information.

When receiving the settlement request from the user terminal device 1, the first settlement server 5A decodes information included in the received settlement request at the code processing unit 50b. The first settlement processing unit 50a of the first settlement server 5A acquires amount information included in decoded information, and commissions settlement of the amount by the second settlement server 5B. At this time, it is to be noted that the first settlement processing unit 50a does not need to transmit a transaction ID, settlement date and time information, and information such as an electronic signature included in the received settlement request to the second settlement server 5B. Moreover, when the first settlement server 5A receives the settlement request, the first settlement processing unit 50a of the first settlement server 5A adds information to the settlement history information 51a in the storage unit 51. The first settlement processing unit 50a stores a transaction ID, and settlement date and time included in the received settlement request in the settlement history information 51a. At this time, the settlement state of corresponding settlement history information 51a is Settlement Not Reached, and a card ID and an update ID are undecided.

When the second settlement server 5B receives a settlement commission from the first settlement server 5A at the communication unit 63, the second settlement processing unit 60a of the second settlement server 5B starts settlement processing to subtract the amount, for which settlement has been commissioned, from the balance in the IC card 7. In the second settlement server 5B, the ID generating unit 60b generates an update ID. The second settlement processing unit 60a gives a read request of the IC card 7 to the first settlement server 5A in order to specify an IC card 7 to be used for settlement processing. It is to be noted that the read request transmitted by the second settlement processing unit 60a includes an update ID. When the read request is given to the first settlement server 5A, the first settlement processing unit 50a of the first settlement server 5A generates a read command to read information (e.g., a card ID 73a) stored in the storage unit 73 of the IC card 7. The first settlement processing unit 50a transmits the generated read command to the user terminal device 1. Moreover, the first settlement processing unit 50a registers an update ID included in the given read request in the settlement history information 51a.

When the user terminal device 1 receives the read command from the first settlement server 5A, the settlement mediation unit 22 of the user terminal device 1 performs non-contact communication with the IC card 7 at the non-contact communication unit 16. The settlement mediation unit 22 transmits the read command to the IC card 7. At this time, the settlement mediation unit 22 may display a massage to prompt contact of the IC card 7 at the display unit 13. The settlement mediation unit 22 transmits a response, which has been obtained from the IC card 7 to a read command through non-contact communication, to the first settlement server 5A. The response obtained from the IC card 7 includes information read from the storage unit 73 such as the card ID 73a. Here, in the present embodiment, the user terminal device 1 and the first settlement server 5A cannot handle said information directly.

When the first settlement server 5A receives the response from the user terminal device 1, the first settlement processing unit 50a of the first settlement server 5A transmits the received response to the second settlement server 5B. When the second settlement server 5B receives the response from the first settlement server 5A, the second settlement processing unit 60a of the second settlement server 5B acquires read information included in the received response. The second settlement processing unit 60a performs such information reading from the IC card 7 a plurality of times, and acquires information on the IC card 7, the balance and the like stored in the storage unit 73 of the IC card 7. It is to be noted that, after acquiring the card ID 73a from the IC card 7, the second settlement processing unit 60a makes a read request to the IC card 7 or the like to the first settlement server 5A with said card ID 73a designated. The first settlement processing unit 50a of the first settlement server 5A registers a card ID in the settlement history information 51a in the storage unit 51 when a card ID 73a is included in the read request.

When acquiring necessary information from the IC card 7, the second settlement processing unit 60a gives a write request to the first settlement server 5A so as to write the amount, which has been obtained by subtracting the commodity price from the balance in the IC card 7, in the IC card 7. When the write request is given to the first settlement server 5A, the first settlement processing unit 50a of the first settlement server 5A generates a write command to write information in the storage unit 73 of the IC card 7, and transmits the write command to the user terminal device 1. The first settlement processing unit 50a changes a corresponding settlement state of the settlement history information 51a in the storage unit 51 into Process Not Completed.

When the user terminal device 1 receives the write command from the first settlement server 5A, the settlement mediation unit 22 of the user terminal device 1 performs non-contact communication with the IC card 7 at the non-contact communication unit 16, and transmits the write command to the IC card 7. The processing unit 70 of the IC card 7 performs write processing to the storage unit 73 according to the write command received from the user terminal device 1 through non-contact communication. Therefore, the balance history information 73b in the storage unit 73 is updated. After termination of write processing, the processing unit 70 of the IC card 7 responds to the user terminal device 1 through non-contact communication. When the user terminal device receives a response from the IC card 7 through non-contact communication, the settlement mediation unit 22 of the user terminal device 1 transmits the received response to the first settlement server 5A. When the first settlement server 5A receives the response from the user terminal device 1, the first settlement processing unit 50a of the first settlement server 5A transmits the received response to the second settlement server 5B.

When the second settlement server 5B receives the response from the first settlement server 5A, the second settlement processing unit 60a of the second settlement server 5B determines whether information writing in the IC card 7 has been succeeded or not from the received response. It is to be noted that FIG. 10 illustrates a case where write processing to the IC card 7 has been succeeded. When write processing has failed, the second settlement processing unit 60a may transmit a write request to the first settlement server 5A repeatedly until write processing is succeeded. When write processing has been succeeded, the second settlement processing unit 60a notifies the first settlement server 5A of completion of settlement processing.

When the first settlement server 5A is notified of Settlement Completed from the second settlement server 5B, the first settlement processing unit 50a of the first settlement server 5A changes a corresponding settlement state of the balance history information 51a in the storage unit 51 into Settlement Reached. The first settlement processing unit 50a transmits a notice that settlement processing has been completed to the user terminal device 1. When the user terminal device 1 receives a completion notice from the first settlement server 5A, the settlement mediation unit 22 of the user terminal device 1 terminates non-contact communication by the non-contact communication unit 16 with the IC card 7. The settlement mediation unit 22 transmits a response that a completion notice has been received to the first settlement server 5A. When the first settlement server 5A receives the response from the user terminal device 1, the first settlement processing unit 50a of the first settlement server 5A gives a response that a notice of completion of settlement processing has been received to the second settlement server 5B. By the response from the first settlement server 5A, the second settlement processing unit 60a of the second settlement server 5B terminates settlement processing.

When the first settlement server 5A receives a response that a notice of completion of settlement processing has been received from the user terminal device 1, the first settlement processing unit 50a of the first settlement server 5A generates a settlement result including the result of settlement processing (Settlement Succeeded in this example) as information. The first settlement processing unit 50a transmits the generated settlement result to the user terminal device 1. Information included in the settlement result is encrypted by the code processing unit 50b. It is to be noted that the first settlement server 5A transmits a result of Settlement Failure when settlement processing cannot be performed normally due to, for example, insufficient balance in the IC card 7. The first settlement server 5A transmits a result of Process Not Completed when, for example, a response from the IC card 7 is not obtained before time-out.

When the user terminal device 1 receives a settlement result from the first settlement server 5A, the settlement result relay unit 23 of the user terminal device 1 transmits the received settlement result from the communication unit 15 to the sales server 3. When the sales server 3 receives the settlement result from the user terminal device 1, the code processing unit 43 of the sales server 3 decodes information included in the received settlement result. The sales processing unit 41 of the sales server 3 updates the settlement result of the sales history information 31a in the storage unit 31 into Settlement Completed, Settlement Failure or Process Not Completed on the basis of the decoded information. When the settlement result is Settlement Succeeded, the sales processing unit 41 proceeds processing of commodity sales to the next step. When a commodity is a digital content, for example, the sales processing unit 41 permits downloading of the digital content. After performing sales processing, the sales processing unit 41 transmits a sales result to the user terminal device 1. When the user terminal device 1 receives the sales result from the sales server 3, processing of sales of a commodity and settlement by a settlement system according to the present embodiment is terminated.

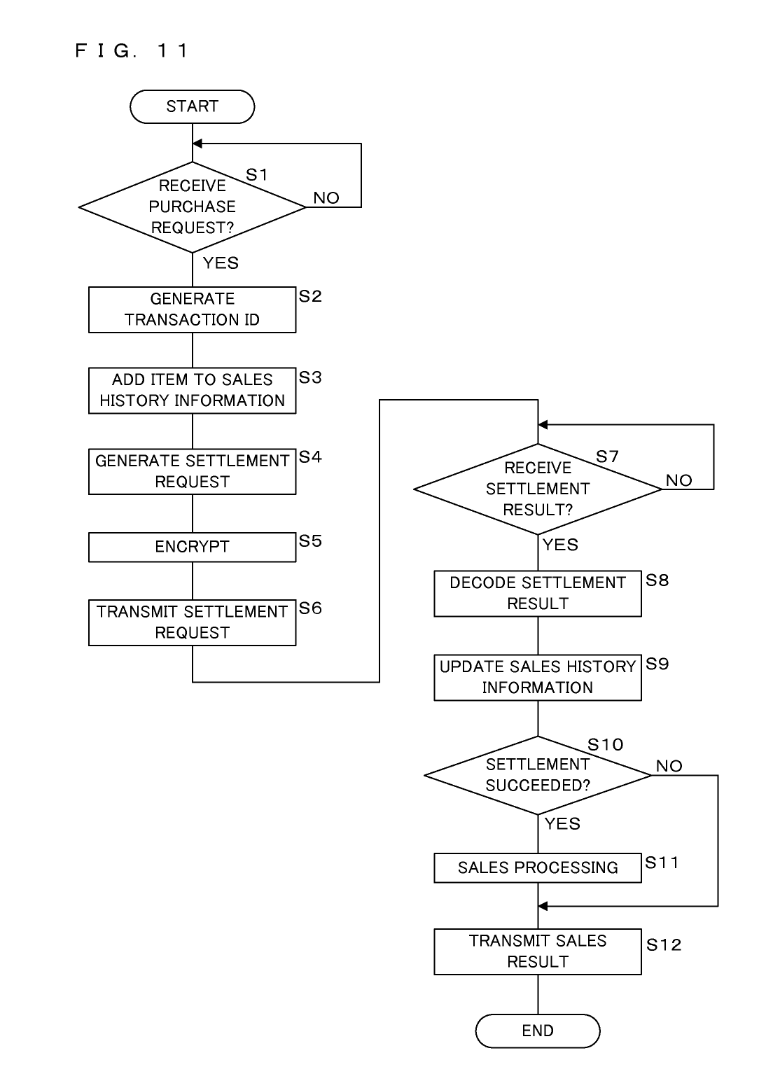

FIG. 11 shows an example non-limiting flowchart for illustrating procedures of settlement processing to be performed by the sales server 3. It is to be noted that description of log-in processing, commodity list transmission processing and the like to be performed with the user terminal device 1 will be omitted in this flowchart. The sales processing unit 41 of the processing unit 30 of the sales server 3 determines whether a purchase request from the user terminal device 1 has been received at the communication unit 33 or not (step S1). When a purchase request has not been received (S1: NO), the sales processing unit 41 waits until a purchase request is received. When a purchase request has been received (S1: YES), the ID generating unit 42 of the processing unit 30 generates a transaction ID (step S2). The sales processing unit 41 adds an item, which is related to the transaction ID generated in step S2, to the sales history information 31a in the storage unit 31 (step S3). The sales processing unit 41 generates a settlement request of a commodity price pertaining to a received purchase request (step S4). The code processing unit 43 of the processing unit 30 encrypts information included in the generated settlement request (step S5). The sales processing unit 41 transmits the encrypted settlement request from the communication unit 33 to the user terminal device 1 (step S6).

The sales processing unit 41 then determines whether a settlement result from the user terminal device 1 has been received at the communication unit 33 or not (step S7). When a settlement result has not been received (S7: NO), the sales processing unit 41 waits until a settlement result is received. When a settlement result has been received (S7: YES), the code processing unit 43 decodes the received settlement result (step S8). The sales processing unit 41 updates information such as the settlement result of the sales history information 31a in the storage unit 31 on the basis of the decoded information (step S9). The sales processing unit 41 determines whether the result of settlement processing is Settlement Succeeded or not (step S10). When settlement processing is succeeded (S10: YES), the sales processing unit 41 performs sales processing pertaining to a commodity, for which purchase has been requested (step S11). The sales processing unit 41 transmits a sales result from the communication unit 33 to the user terminal device 1 (step S12), and terminates the process. When settlement processing is not succeeded (S10: NO), the sales processing unit 41 transmits a sales result that sales processing is not succeeded to the user terminal device 1 (step S12) without performing sales processing, and terminates the process.

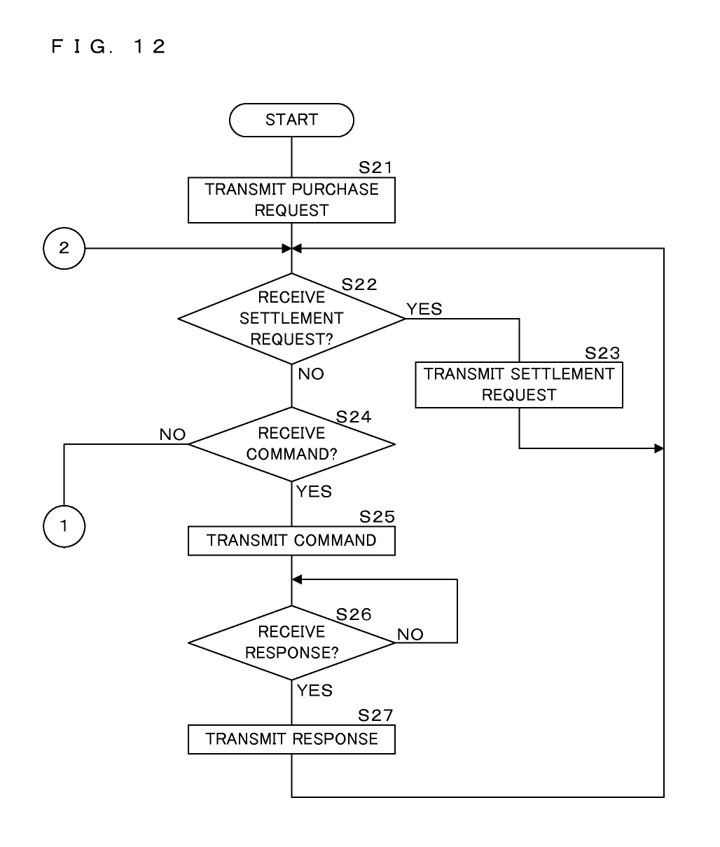

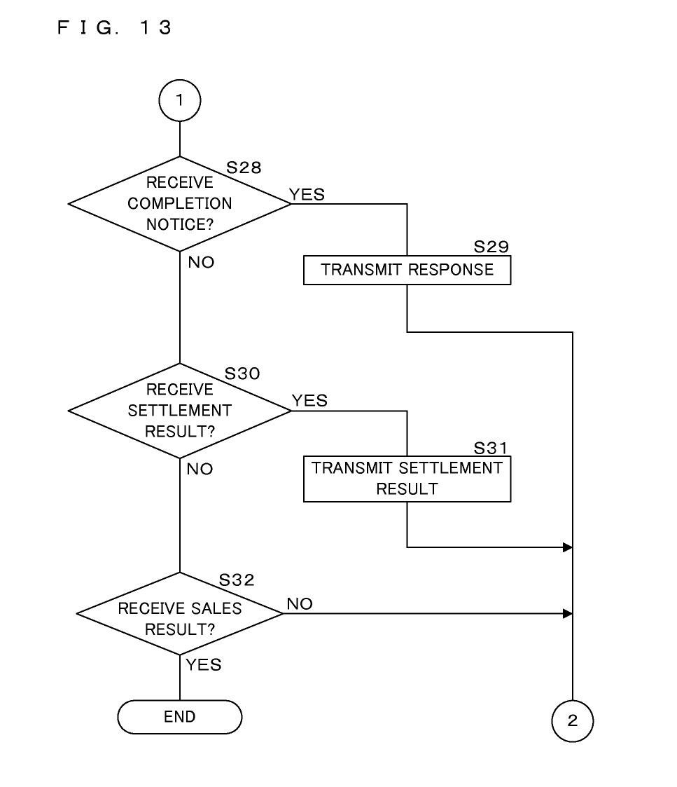

FIGS. 12 and 13 show an example non-limiting flowchart for illustrating procedures of relay processing to be performed by the user terminal device 1. In the processing unit 10 of the user terminal device 1, the operation acceptance unit 25 accepts operation for commodity purchase at the operation unit 14. The purchase processing unit 24 of the processing unit 10 transmits a purchase request of a commodity from the communication unit 15 to the sales server 3 in response to accepted purchase operation (step S21). The processing unit 10 then determines whether a settlement request from the sales server 3 has been received at the communication unit 15 or not (step S22). When a settlement request from the sales server 3 has been received (S22: YES), the settlement request relay unit 21 of the processing unit 10 transmits the received settlement request from the communication unit 15 to the first settlement server 5A (step S23), and returns the process to step S22.

When a settlement request has not been received (S22: NO), the processing unit 10 determines whether a command of processing to the IC card 7 from the first settlement server 5A has been received or not (step S24). When a command has been received (S24: YES), the settlement mediation unit 22 of the processing unit 10 transmits the received command from the non-contact communication unit 16 to the IC card 7 (step S25). The settlement mediation unit 22 determines whether a response from the IC card 7 has been received at the non-contact communication unit 16 or not (step S26). When a response has not been received (S26: NO), the settlement mediation unit 22 waits until a response is received. When a response has been received (S26: YES), the settlement mediation unit 22 transmits the received response from the communication unit 15 to the first settlement server 5A (step S27), and returns the process to step S22.

When a command has not been received (S24: NO), the processing unit 10 determines whether a completion notice from the first settlement server 5A has been received or not (step S28). When a completion notice has been received (S28: YES), the processing unit 10 transmits a response to the first settlement server 5A (step S29), and returns the process to step S22. When a completion notice has not been received (S28: NO), the processing unit 10 determines whether a settlement result from the first settlement server 5A has been received or not (step S30). When a settlement result has been received (S30: YES), the settlement result relay unit 23 of the processing unit 10 transmits the received settlement result from the communication unit 15 to the sales server 3 (step S31), and returns the process to step S22. When a settlement result has not been received (step S30: NO), the processing unit 10 determines whether a sales result from the sales server 3 has been received or not (step S32). When a sales result has not been received (S32: NO), the processing unit 10 returns the process to step S22. When a sales result has been received (S32: YES), the processing unit 10 terminates the process.

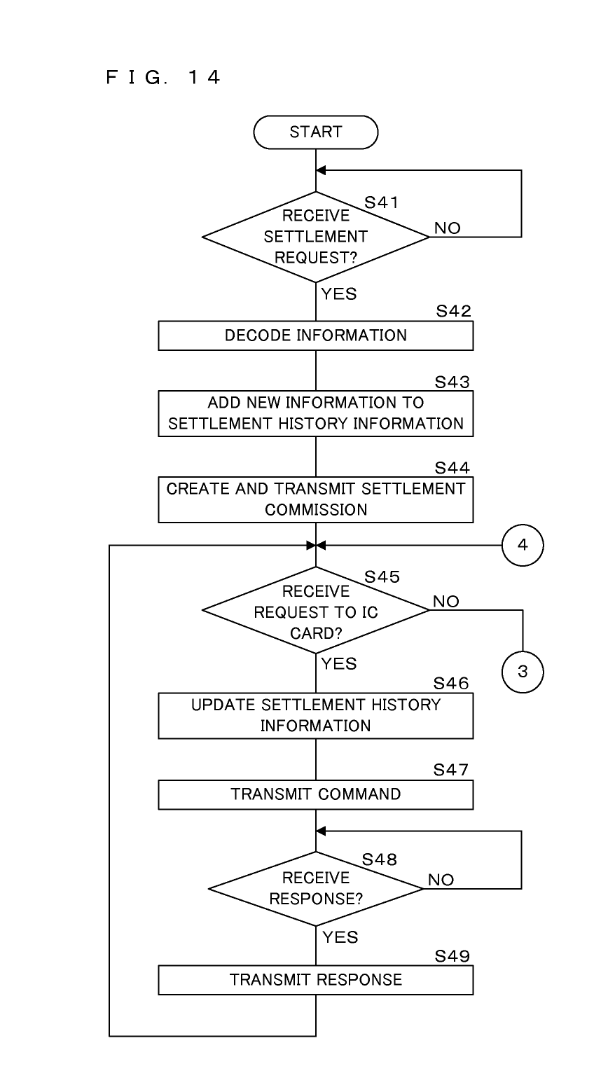

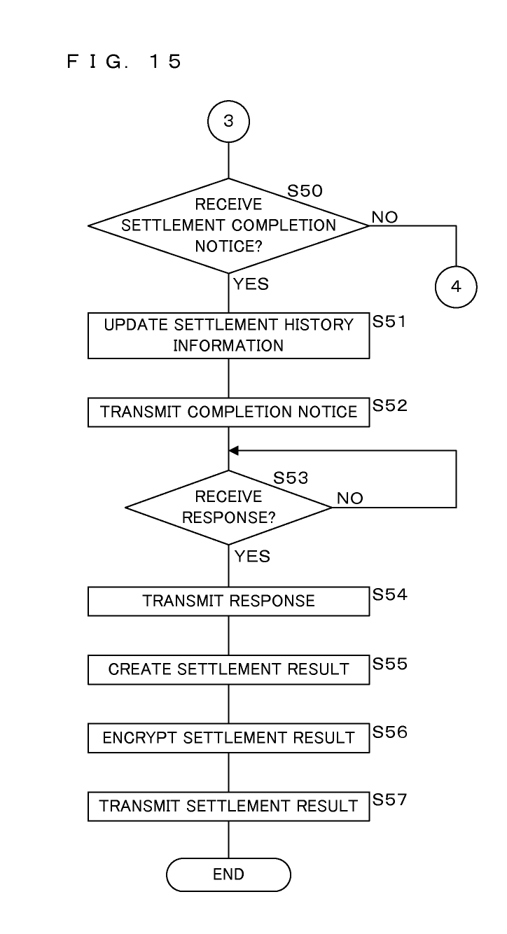

FIGS. 14 and 15 show an example non-limiting flowchart for illustrating procedures of settlement processing to be performed by the first settlement server 5A. The first settlement processing unit 50a of the processing unit 50 of the first settlement server 5A determines whether a settlement request from the user terminal device 1 has been received at the communication unit 53 or not (step S41). When a settlement request has not been received (S41: NO), the first settlement processing unit 50a waits until a settlement request is received. When a settlement request has been received (S41: YES), the code processing unit 50b of the processing unit 50 decodes information included in the received settlement request (step S42). The first settlement processing unit 50a adds new information to the settlement history information 51a in the storage unit 51 on the basis of the decoded information (step S43). The first settlement processing unit 50a creates a settlement commission to the second settlement server 5B on the basis of the decoded information, and transmits the settlement commission from the communication unit 53 to the second settlement server 5B (step S44).

The first settlement processing unit 50a determines whether a processing request for reading, writing or the like to the IC card 7 from the second settlement server 5B has been received at the communication unit 53 or not (step S45). When a request to the IC card 7 has been received (S45: YES), the first settlement processing unit 50a updates information, such as the settlement state, a card ID or an update ID of the settlement history information 51a in the storage unit 51, as necessary on the basis of the received request (step S46). The first settlement processing unit 50a creates a command to the IC card 7 corresponding to the received request, and transmits the command from the communication unit 53 to the user terminal device 1 (step S47). The first settlement processing unit 50a determines whether a response from the user terminal device 1 to the transmitted command has been received at the communication unit 53 or not (step S48). When a response has not been received (S48: NO), the first settlement processing unit 50a waits until a response is received. When a response has been received (S48: YES), the first settlement processing unit 50a transmits the response, which has been received from the user terminal device 1, from the communication unit 53 to the second settlement server 5B (step S49), and returns the process to step S45.

When a request for processing to the IC card 7 has not been received (S45: NO), the first settlement processing unit 50a determines whether a settlement completion notice from the second settlement server 5B has been received at the communication unit 53 or not (step S50). When a settlement completion notice has not been received (S50: NO), the first settlement processing unit 50a returns the process to step S45. When a settlement completion notice has been received (S50: YES), the first settlement processing unit 50a updates the settlement state of the settlement history information 51a in the storage unit 51 on the basis of the received settlement completion notice (step S51). The first settlement processing unit 50a transmits a completion notice of settlement processing from the communication unit 53 to the user terminal device 1 (step S52).

The first settlement processing unit 50a determines whether a response from the user terminal device 1 to the completion notice has been received at the communication unit 53 or not (step S53). When a response has not been received (S53: NO), the first settlement processing unit 50a waits until a response is received. When a response has been received (S53: YES), the first settlement processing unit 50a transmits a response to the settlement completion notice from the communication unit 53 to the second settlement server 5B (step S54). The first settlement processing unit 50a creates a settlement result to be transmitted to the sales server 3 (step S55). The code processing unit 50b encrypts information included in the created settlement result (step S56). The first settlement processing unit 50a transmits the encrypted settlement result from the communication unit 53 to the user terminal device 1 (step S57), and terminates the process.

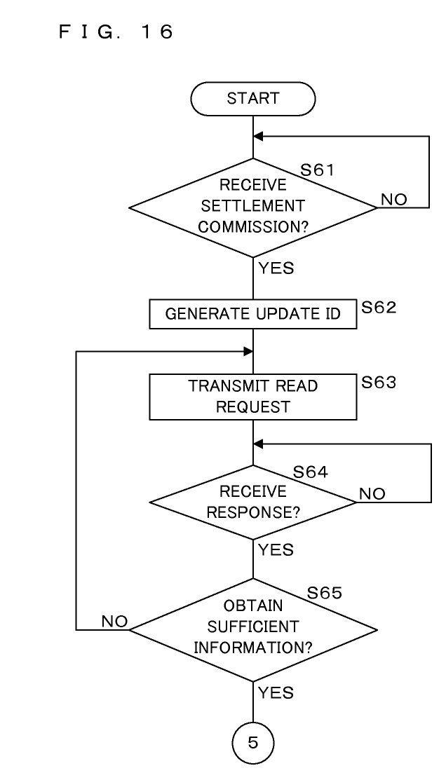

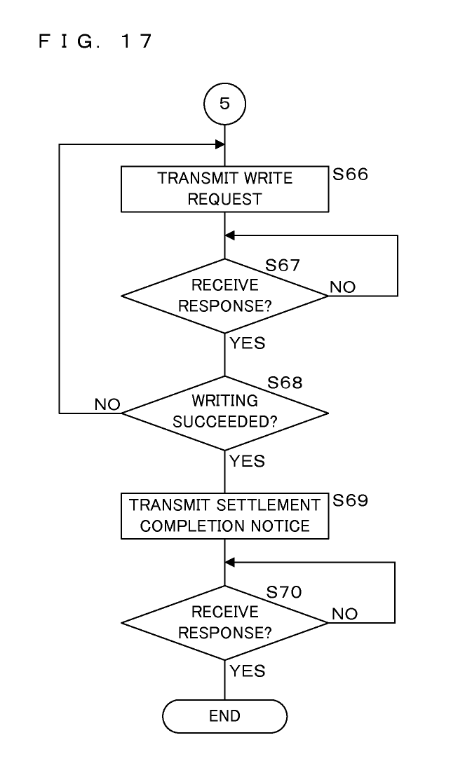

FIGS. 16 and 17 show an example non-limiting flowchart for illustrating procedures of settlement processing to be performed by the second settlement server 5B. The second settlement processing unit 60a of the processing unit 60 of the second settlement server 5B determines whether a settlement commission from the first settlement server 5A has been received at the communication unit 63 or not (step S61). When a settlement commission has not been received (S61: NO), the second settlement processing unit 60a waits until a settlement commission is received. When a settlement commission has been received (S61: YES), the ID generating unit 60b of the processing unit 60 generates an update ID (step S62).

The second settlement processing unit 60a transmits a read request of information from the IC card 7 with the generated update ID attached from the communication unit 63 to the first settlement server 5A (step S63). The second settlement processing unit 60a determines whether a response from the first settlement server 5A to the read request has been received at the communication unit 63 or not (step S64). When a response has not been received (S64: NO), the second settlement processing unit 60a waits until a response is received. When a response has been received (S64: YES), the second settlement processing unit 60a determines whether sufficient information to be used for updating the balance in the IC card 7 has been obtained by reading information from the IC card 7 or not (step S65). When sufficient information has not been obtained (S65: NO), the second settlement processing unit 60a returns the process to step S63 and repeats information reading from the IC card 7.

When sufficient information has been obtained (S65: YES), the second settlement processing unit 60a transmits a write request to write new balance information in the IC card 7 from the communication unit 63 to the first settlement server 5A (step S66). The second settlement processing unit 60a determines whether a response from the first settlement server 5A to the write request has been received at the communication unit 63 or not (step S67). When a response has not been received (S67: NO), the second settlement processing unit 60a waits until a response is received. When a response has been received (S67: YES). The second settlement processing unit 60a determines whether writing in the IC card 7 has been succeeded or not on the basis of the received response (step S68). When writing has not been succeeded (S68: NO), the second settlement processing unit 60a returns the process to step S66, and repeats writing in the IC card 7.

When writing in the IC card 7 has been succeeded (S68: YES), the second settlement processing unit 60a transmits a settlement completion notice for reporting completion of settlement processing from the communication unit 63 to the first settlement server 5A (step S69). The second settlement processing unit 60a determines whether a response from the first settlement server 5A to the settlement completion notice has been received at the communication unit 63 or not (step S70). When a response has not been received (S70: NO), the second settlement processing unit 60a waits until a response is received. When a response has been received (S70: YES), the second settlement processing unit 60a terminates the process.

<Restoration Processing from Communication Malfunction>

In a settlement system according to the present embodiment, a malfunction can occur in communication via the network 99. A malfunction can occur in, for example, communication between the sales server 3 and the user terminal device 1, communication between the user terminal device 1 and the first settlement server 5A, communication between the first settlement server 5A and the second settlement server 5B, or communication between the user terminal device 1 and the IC card 7 through non-contact communication. When a malfunction occurs in such communication, settlement processing described above or the like can be suspended and processing at each device can be terminated abnormally. Therefore, a status can arise such that sales processing of a commodity has not been completed, although the balance in the IC card 7 has been decreased, for example. As a result, a settlement system according to the present embodiment performs processing to restore processing which has been suspended by a malfunction.

When sales processing and settlement processing are suspended due to a malfunction in communication, for example, the settlement result of the sales history information 31a stored in the storage unit 31 of the sales server 3 becomes Settlement Failure or Not Received, and the sales processing status becomes Not Completed regarding the suspended processing. Accordingly, for example, the sales processing unit 41 of the sales server 3 retrieves the sales history information 31a on the basis of the user ID, and determines whether processing having a sales processing status which is Not Completed or not exists when the user utilizes the user terminal device 1 so as to perform log-in processing to the system. When there is incomplete processing, the sales processing unit 41 notifies the user terminal device 1 of the fact that there is incomplete processing from the communication unit 33. When the notice is received at the communication unit 15 of the user terminal device 1, the purchase processing unit 24 of the user terminal device 1 displays a massage that there is incomplete processing at the display unit 13. The operation acceptance unit 25 accepts selection of whether the process is to be restarted or not at the operation unit 14. Message display by the user terminal device 1 is achieved at least before the next settlement processing is started. When the user selects at the user terminal device 1 to restart suspended processing, restoration processing of a settlement system according to the present embodiment is started.

In restoration processing, the malfunction confirmation unit 44 of the processing unit 30 of the sales server 3 first performs processing to confirm where in process steps of settlement processing a malfunction has occurred. In the present embodiment, the malfunction confirmation unit 44 confirms which of following four states the settlement processing is suspended in.
(1) A state where a settlement request from the sales server 3 has not reached the first settlement server 5A (Not Requested).

(2) A state where a settlement request has reached but a write command to the IC card 7 has not been transmitted from the first settlement server 5A to the user terminal device 1 (Settlement Not Reached).

(3) A state where a write command has been transmitted but a response from the user terminal device 1 to the command has not reached the first settlement server 5A (Process Not Completed).

(4) A state where the balance in the IC card 7 has been updated but a settlement result has not reached the sales server 3 (Settlement Completed).

The malfunction confirmation unit 44 of the sales server 3 transmits a request to confirm the state of settlement processing via the user terminal device 1 to the first settlement server 5A with a transaction ID pertaining to suspended processing designated. In response to the request, the malfunction determination unit 50c of the processing unit 30 of the first settlement server 5A acquires a settlement state corresponding to the designated transaction ID from the settlement history information 51a stored in the storage unit 51. When information corresponding to the designated transaction ID is not stored in the settlement history information 51a, the malfunction determination unit 50c can determine that the process is in the above state (1). When the settlement state is Settlement Not Reached, the malfunction determination unit 50c can determine that the process is in the above state (2). When the settlement state is Process Not Completed, the malfunction determination unit 50c can determine that the process is in the above state (3). When the settlement state is Settlement Reached, the malfunction determination unit 50c can determine that the process is in the above state (4). The malfunction determination unit 50c transmits such a determination result via the user terminal device 1 to the sales server 3.

When the process is in any one of the above states (1) or (2), the processing unit 30 of the sales server 3 can restart settlement processing by retransmitting a settlement request related to a commodity of incomplete sales processing. When the process is in the above state (4), subtraction of a commodity price from the IC card 7 has been completed and settlement processing has been completed, and therefore the processing unit 30 of the sales server 3 can restart sales processing considering that settlement processing has been completed. On the other hand, in the case of the above state (3), whether information writing in the IC card 7 has been completed or not is unclear. As a result, the sales server 3 makes an inquiry about the balance history information 73b stored in the storage unit 73 of the IC card 7.

In such a case, the malfunction confirmation unit 44 of the sales server 3 requests inquiry of the balance history information in the IC card 7 via the user terminal device 1 to the first settlement server 5A with a transaction ID designated. In response to the request, the malfunction determination unit 50c of the first settlement server 5A gives a request for inquiry of balance history in the IC card 7 to the second settlement server 5B. It is to be noted that the first settlement server 5A can also be constructed to perform processing to read the balance history information 73b from the IC card 7 at this time. Here, a settlement system according to the present embodiment is constructed in a manner such that the second settlement server 5B writes and reads information in and from the IC card 7 and the first settlement server 5A requests inquiry of balance history to the second settlement server 5B.

In response to the request from the first settlement server 5A, the history inquiry unit 60c of the processing unit 60 of the second settlement server 5B gives a read request of the balance history information 73b via the first settlement server 5A and the user terminal device 1 to the IC card 7. Information read from the IC card 7 in response to the read request is given via the user terminal device 1 and the first settlement server 5A to the second settlement server 5B. It is to be noted that the present embodiment is constructed in a manner such that the first settlement server 5A cannot handle directly information read from the IC card 7. The history inquiry unit 60c of the second settlement server 5B transmits the balance history information 73b read from the IC card 7 to the first settlement server 5A. It is to be noted that the history inquiry unit 60c in the present embodiment reads all the history of the balance history information 73b from the IC card 7, and transmits the history to the first settlement server 5A.

When the first settlement server 5A receives the balance history information 73b from the second settlement server 5B, the malfunction determination unit 50c of the first settlement server 5A acquires an update ID corresponding to the transaction ID from the settlement history information 51a in the storage unit 51. The malfunction determination unit 50c determines whether history related to the acquired update ID exists in the balance history information 73b or not. When history with a matching update ID exists, the malfunction determination unit 50c determines that writing in the IC card 7 has been completed. When history with a matching update ID does not exist, the malfunction determination unit 50c determines that writing in the IC card 7 has not been completed. The malfunction determination unit 50c transmits the determination result via the user terminal device 1 to the sales server 3.

When a result of history inquiry of the IC card 7 shows that writing in the IC card 7 has not been completed, the processing unit 30 of the sales server 3 can restart settlement processing by retransmitting a settlement request related to a commodity, sales processing of which is incomplete. This is similar to the case of the above states (1) and (2). On the other hand, when writing in the IC card 7 has been completed, the processing unit 30 of the sales server 3 can restart settlement processing considering that settlement processing has been completed. This is similar to the case of the above state (4).

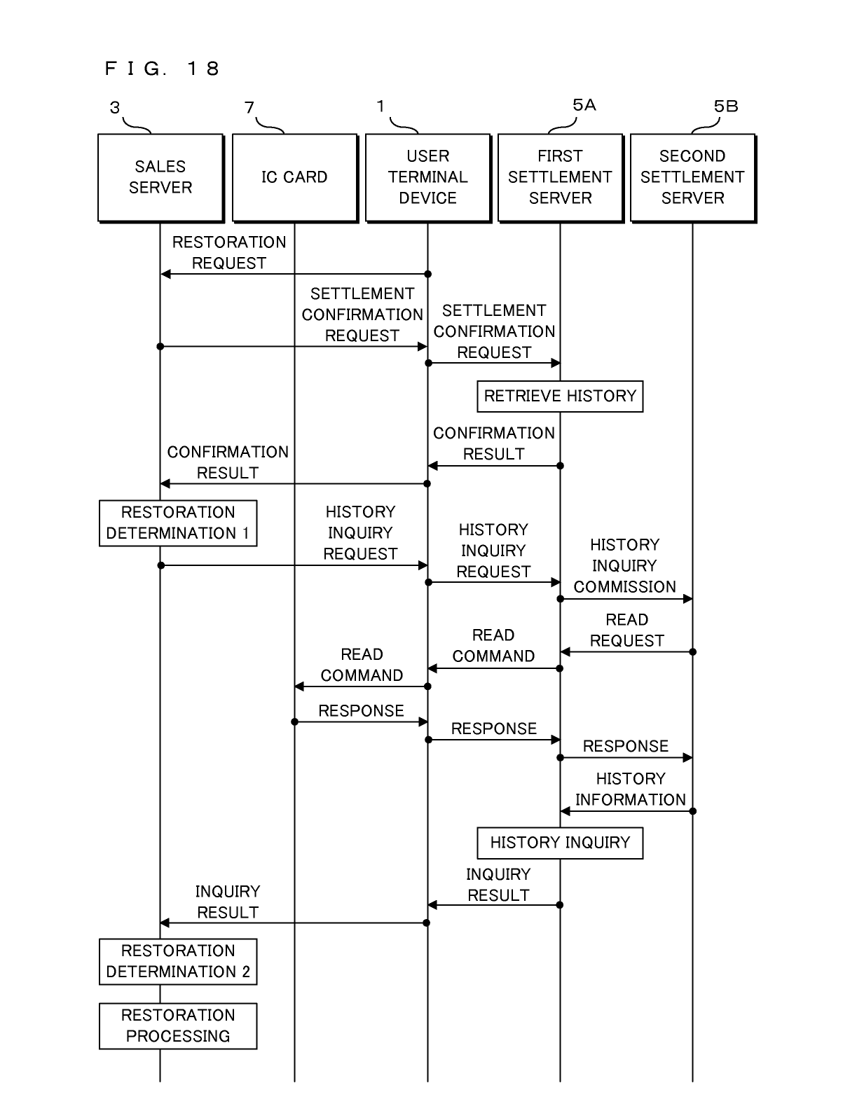

FIG. 18 shows an example non-limiting schematic diagram for illustrating an example of malfunction confirmation processing of a settlement system according to the present embodiment. When a message indicating that a malfunction has occurred in sales processing and settlement processing is displayed at the display unit 13 of the user terminal device 1, for example, the user can operate the operation unit 14 so as to request restoration of processing in which a malfunction has occurred. The user terminal device 1 transmits a restoration request including information such as a user ID and a transaction ID related to suspended processing, for example, from the communication unit 15 to the sales server 3.

When the sales server 3 receives the restoration request from the user terminal device 1 at the communication unit 33, the malfunction confirmation unit 44 of the sales server 3 creates a settlement confirmation request to confirm the suspended state of settlement processing with a transaction ID related to processing, for which restoration has been requested, designated. The malfunction confirmation unit 44 transmits the created settlement confirmation request from the communication unit 33 to the user terminal device 1. It is to be noted that information included in the settlement confirmation request may be encrypted by the code processing unit 43. When the user terminal device 1 receives the settlement confirmation request from the sales server 3 at the communication unit 15, the processing unit 10 of the user terminal device 1 transmits the received settlement confirmation request from the communication unit 15 to the first settlement server 5A.

When the first settlement server 5A receives the settlement confirmation request from the user terminal device 1, the malfunction determination unit 50c of the first settlement server 5A retrieves the settlement history information 51a in the storage unit 51. The malfunction determination unit 50c determines whether transaction ID information included in the received settlement confirmation request is stored or not, and determines the settlement state when the transaction ID information is stored. The malfunction determination unit 50c therefore can determine which of (1) Not Requested, (2) Settlement Not Reached, (3) Process Not Completed and (4) Settlement Reached the state of suspended processing is. The malfunction determination unit 50c transmits the determination result to the user terminal device 1 as a confirmation result of a malfunction. When the user terminal device 1 receives the confirmation result from the first settlement server 5A, the processing unit 10 of the user terminal device 1 transmits the received confirmation result to the sales server 3.

When the sales server 3 receives the confirmation result from the user terminal device 1, the malfunction confirmation unit 44 of the sales server 3 determines from where the suspended processing is to be restored, on the basis of the received confirmation result (Restoration Determination 1 in the figure). When the confirmation result is (1) Not Requested or (2) Settlement Not Reached, the malfunction confirmation unit 44 generates a settlement request to restart settlement processing from the beginning, and transmits the settlement request to the user terminal device 1. When the confirmation result is (4) Settlement Reached, which means that settlement processing has been completed, the malfunction confirmation unit 44 restarts the process from processing pertaining to sales of a commodity. When the confirmation result is (3) Process Not Completed, the malfunction confirmation unit 44 transmits a history inquiry request to the user terminal device 1 with a transaction ID designated so as to make an inquiry about the balance history information 73b in the IC card 7. It is to be noted that FIG. 18 illustrates an example of processing based on an assumption that the confirmation result is (3) Process Not Completed.

When receiving the history inquiry request from the sales server 3, the user terminal device 1 transmits the received history inquiry request to the first settlement server 5A. When the first settlement server 5A receives the history inquiry request from the user terminal device 1, the malfunction determination unit 50c of the first settlement server 5A acquires a card ID corresponding to the transaction ID included in the received history inquiry request from the settlement history information 51a in the storage unit 51. The malfunction determination unit 50c transmits a history inquiry commission, which designates an acquired card ID, to the second settlement server 5B.

When the second settlement server 5B receives the history inquiry commission from the first settlement server 5A at the communication unit 63, the history inquiry unit 60c of the second settlement server 5B starts processing to read the balance history information 73b from the IC card 7 having the designated card ID. It is to be noted that reading of the balance history information 73b from the IC card 7 by the second settlement server 5B is implemented in a plurality of times of information interchange between the second settlement server 5B and the IC card 7. Here, in FIG. 18, the read processing is described in a simplified manner such that reading of the balance history information 73b is achieved in one time of information interchange. The history inquiry unit 60c of the second settlement server 5B transmits a read request to read the balance history information 73b from the IC card 7 to the first settlement server 5A.

When the read request is given, the first settlement server 5A generates a read command to read the balance history information 73b from the IC card 7, and transmits the read command to the user terminal device 1. When the user terminal device 1 receives the read command from the first settlement server 5A, the processing unit 10 of the user terminal device 1 performs non-contact communication at the non-contact communication unit 16 with the IC card 7, and transmits the read command to the IC card 7. The processing unit 10 transmits a response, which has been obtained from the IC card 7 to the read command, to the first settlement server 5A. It is to be noted that a response obtained from the IC card 7 is the balance history information 73b. When the first settlement server 5A receives the response from the user terminal device 1, the malfunction determination unit 50c of the first settlement server 5A transmits the received response to the second settlement server 5B. When the second settlement server 5B receives the response from the first settlement server 5A, the history inquiry unit 60c of the second settlement server 5B acquires the balance history information 73b included in the received response. The history inquiry unit 60c transmits the acquired balance history information 73b to the first settlement server 5A.

When the first settlement server 5A receives the balance history information 73b from the second settlement server 5B, the malfunction determination unit 50c of the first settlement server 5A acquires an update ID, which corresponds to a transaction ID designated in the history inquiry request from the sales server 3, from the settlement history information 51a in the storage unit 51. The malfunction determination unit 50c determines whether the history of the acquired update ID is included in the balance history information 73b or not. When an update ID which is the object of inquiry is included in the balance history information 73b, the malfunction determination unit 50c determines that writing in the IC card 7 has been completed. When an update ID which is the object of inquiry is not included in the balance history information 73b, the malfunction determination unit 50c determines that writing in the IC card 7 has not been completed. The malfunction determination unit 50c transmits the determination result to the user terminal device 1 as an inquiry result. When the user terminal device 1 receives the inquiry result from the first settlement server 5A, the processing unit 10 of the user terminal device 1 transmits the received inquiry result to the sales server 3.

When the sales server 3 receives the inquiry result from the user terminal device 1, the malfunction confirmation unit 44 of the sales server 3 determines from where the suspended settlement processing is to be restored, on the basis of the received inquiry result (Restoration Determination 2 in the figure). When it is determined from the received inquiry result that writing in the IC card 7 has not been completed, the malfunction confirmation unit 44 generates a settlement request so as to restart settlement processing from the beginning, and transmits the settlement request to the user terminal device 1. When it is determined that writing in the IC card 7 has been completed, which means that settlement processing has been completed, the malfunction confirmation unit 44 restarts the process from processing pertaining to sales of a commodity. The processing unit 10 of the sales server 3 starts restoration processing of the suspended processing in a method which has been determined in Restoration Determination 1 or Restoration Determination 2.

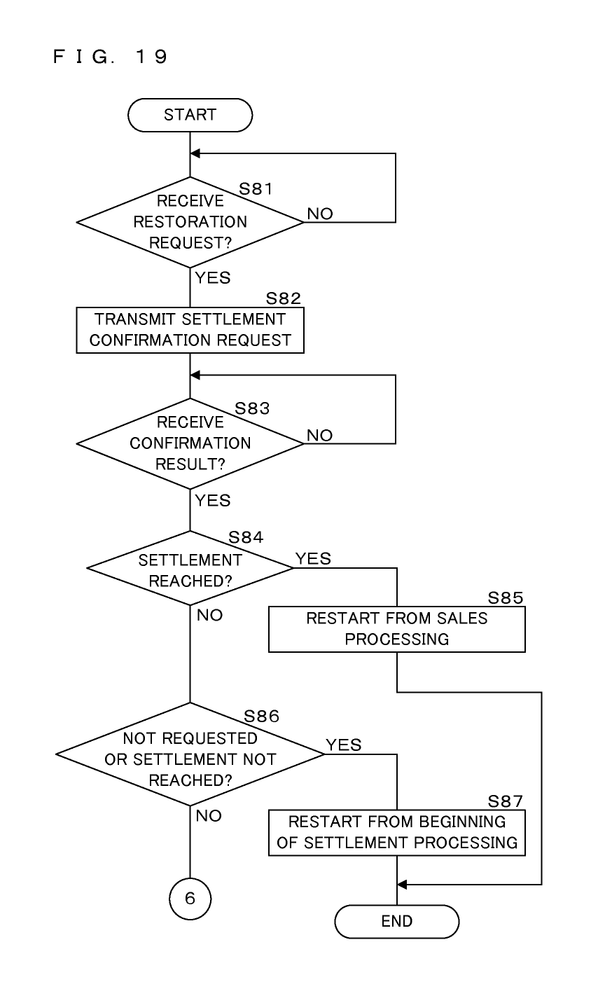

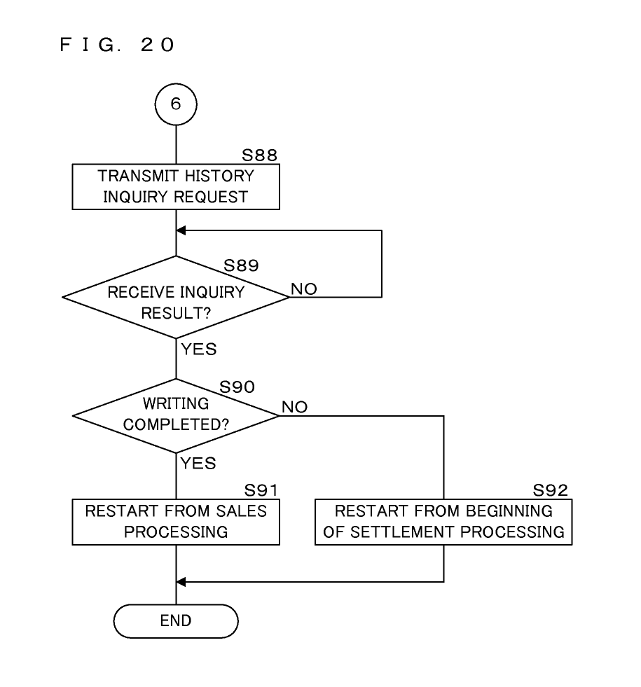

FIGS. 19 and 20 show an example non-limiting flowchart for illustrating procedures of restoration processing to be performed by the sales server 3. The malfunction confirmation unit 44 of the processing unit 30 of the sales server 3 determines whether a restoration request from the user terminal device 1 has been received at the communication unit 33 or not (step S81). When a restoration request has not been received (S81: NO), the malfunction confirmation unit 44 waits until a restoration request is received. When a restoration request has been received (S81: YES), the malfunction confirmation unit 44 transmits a settlement confirmation request designating a transaction ID of processing, for which restoration has been requested, from the communication unit 33 to the user terminal device 1 (step S82). The malfunction confirmation unit 44 then determines whether a confirmation result from the user terminal device 1 has been received at the communication unit 33 or not (step S83). When a confirmation result has not been received (S83: NO), the malfunction confirmation unit 44 waits until a confirmation result is received.

When a confirmation result has been received (S83: YES), the malfunction confirmation unit 44 determines whether the received confirmation result is Settlement Reached or not (step S84). When the confirmation result is Settlement Reached (S84: YES), which means that settlement processing has been completed, the malfunction confirmation unit 44 restarts the process from sales processing after settlement processing (step S85), and terminates restoration processing. When a confirmation result is not Settlement Reached (S84: NO), the malfunction confirmation unit 44 determines whether the confirmation result is any one of Not Requested and Settlement Not Reached or not (step S86). When the confirmation result is any one of Not Requested and Settlement Not Reached (S86: YES), the malfunction confirmation unit 44 restarts the process from the beginning of settlement processing (step S87), and terminates restoration processing.

When the confirmation result is not one of Not Requested and Settlement Not Reached (S86: NO), that is, when the confirmation result is Process Not Completed, the malfunction confirmation unit 44 transmits a history inquiry request from the communication unit 33 to the communication user terminal device 1 so as to make an inquiry about the balance history information 73b in the IC card 7 used for settlement processing (step S88). The malfunction confirmation unit 44 determines whether an inquiry result from the user terminal device 1 to the history inquiry request has been received at the communication unit 33 or not (step S89). When an inquiry result has not been received (S89: NO), the malfunction conformation unit 44 waits until an inquiry result is received. When an inquiry result has been received (S89: YES), the malfunction confirmation unit 44 determines whether the received inquiry result is Writing Completed or not (step S90). When the inquiry result is Writing Completed (S90: YES), the malfunction confirmation unit 44 restarts the process from sales processing after settlement processing (step S91), and terminates restoration processing. When the inquiry result is not Writing Completed (S90: NO), the malfunction confirmation unit 44 restarts the process from the beginning of settlement processing (step S92), and terminates restoration processing.

It is to be noted that illustration of a flowchart related to processing to be performed by the user terminal device 1 in restoration processing is omitted. The user terminal device 1 performs processing to transmit information, which has been received from the sales server 3, to the first settlement server 5A, processing to transmit a command, which has been received from the first settlement server 5A, to the IC card 7 through non-contact communication, and processing to transmit information, which has been received from the first settlement server 5A, to the sales server 3.

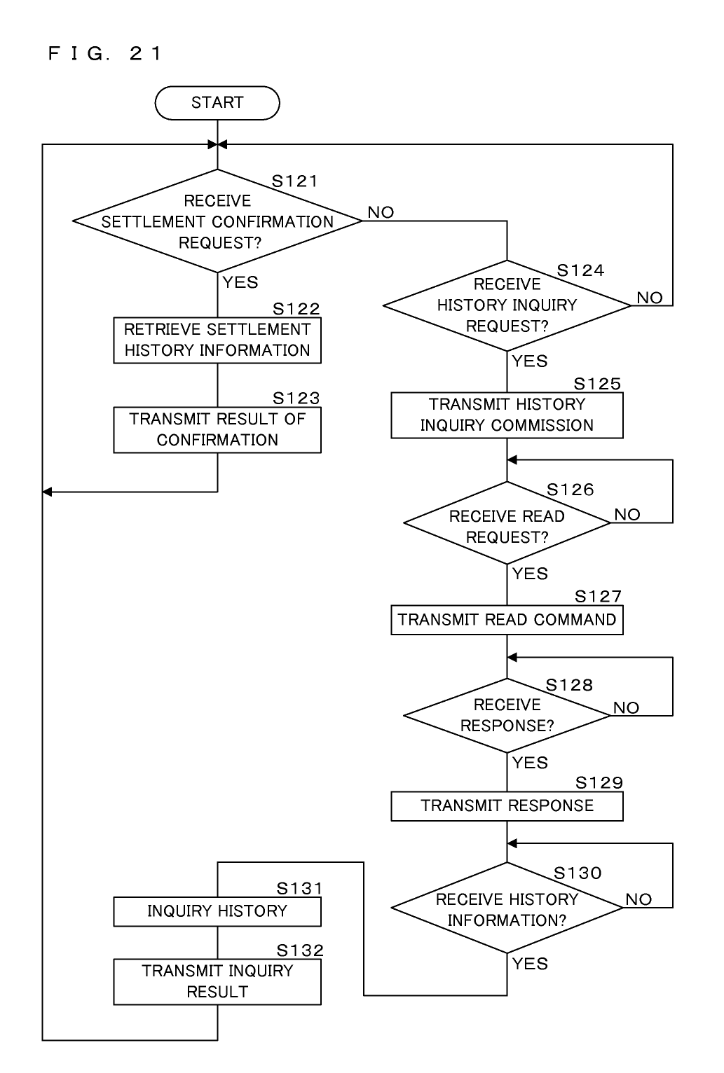

FIG. 21 shows an example non-limiting flowchart for illustrating procedures of malfunction determination processing to be performed by the first settlement server 5A. The malfunction determination unit 50c of the processing unit 50 of the first settlement server 5A determines whether a settlement confirmation request from the user terminal device 1 has been received at the communication unit 53 or not (step S121). When a settlement confirmation request has been received (S121: YES), the malfunction determination unit 50c retrieves the settlement history information 51a stored in the storage unit 51 so as to determine the settlement state corresponding to the transaction ID designated by the received settlement confirmation request (step S122). The malfunction determination unit 50c transmits the result of confirmation indicating which of Not Requested, Settlement Not Reached, Process Not Completed and Settlement Reached the settlement state is, on the basis of the result of retrieval of the settlement history information 51a from the communication unit 53 to the user terminal device 1 (step S123), and returns the process to step S121.

When a settlement confirmation request from the user terminal device 1 has not been received (S121: NO), the malfunction determination unit 50c determines whether a history inquiry request from the user terminal device 1 has been received or not (step S124). When a history inquiry request has not been received (S124: NO), the malfunction determination unit 50c returns the process to step S121. When a history inquiry request has been received (S124: YES), the malfunction determination unit 50c acquires a card ID corresponding to the transaction ID, which is designated by the received history inquiry request, from the settlement history information 51a. The malfunction determination unit 50c transmits a history inquiry commission related to the obtained card ID from the communication unit 53 to the second settlement server 5B (step S125).

The malfunction determination unit 50c determines whether a read request to the IC card 7 from the second settlement server 5B has been received at the communication unit 53 or not (step S126). When a read request has not been received (S126: NO), the malfunction determination unit 50c waits until a read request is received. When a read request has been received (S126: YES), the malfunction determination unit 50c creates a read command to the IC card 7 corresponding to the received read request, and transmits the read command to the user terminal device 1 (step S127). The malfunction determination unit 50c determines whether a response from the user terminal device 1 to the transmitted read command has been received at the communication unit 53 or not (step S128). When a response has not been received (S128: NO), the malfunction determination unit 50c waits until a response is received. When a response has been received (S128: YES), the malfunction determination unit 50c transmits the response, which has been received from the user terminal device 1, from the communication unit 53 to the second settlement server 5B (step S129).

The malfunction determination unit 50c determines whether the balance history information 73b from the second settlement server 5B has been received at the communication unit 53 or not (step S130). When the balance history information 73b has not been received (S130: NO), the malfunction determination unit 50c waits until the balance history information 73b is received. When the balance history information 73b has been received (S130: YES), the malfunction determination unit 50c acquires an update ID corresponding to a transaction ID, which is designated by the history inquiry request, from the settlement history information 51a. The malfunction determination unit 50c makes an inquiry about the received balance history information 73b using the acquired update ID (step S131), so as to determine whether history related to the update ID is included in the balance history information 73b or not. The malfunction determination unit 50c therefore determines whether writing in the IC card 7 has been completed or not. The malfunction determination unit 50c transmits the determination result to the user terminal device 1 as an inquiry result (step S132), and returns the process to step S121.

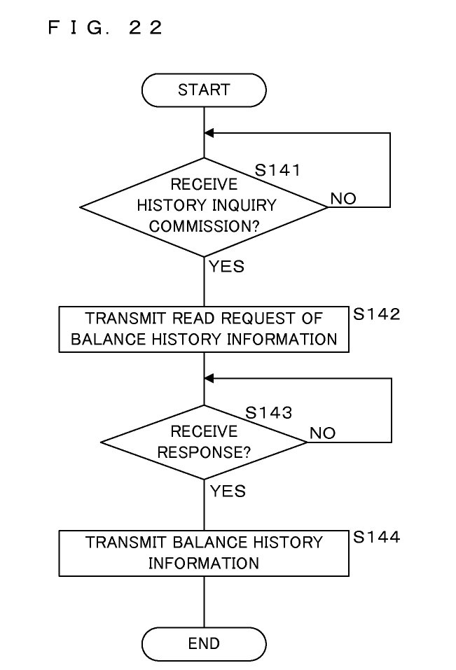

FIG. 22 shows an example non-limiting flowchart for illustrating procedures of history inquiry processing to be performed by the second settlement server 5B. The history inquiry unit 60c of the processing unit 60 of the second settlement server 5B determines whether a history inquiry commission from the first settlement server 5A has been received at the communication unit 63 or not (step S141). When a history inquiry commission has not been received (S141: NO), the history inquiry unit 60c waits until a history inquiry commission is received. When a history inquiry commission has been received (S141: YES), the history inquiry unit 60c generates a read request of the balance history information 73b to the IC card 7 having a card ID designated by the history inquiry commission. The history inquiry unit 60c transmits the generated read request from the communication unit 63 to the first settlement server 5A (step S142).

The history inquiry unit 60c determines whether a response from the first settlement server 5A to the read request has been received at the communication unit 63 or not (step S143). When a response has not been received (S143: NO), the history inquiry unit 60c waits until a response is received. When a response has been received (S143: YES), the history inquiry unit 60c acquires the balance history information 73b included in the response. The history inquiry unit 60c transmits the acquired balance history information 73b from the communication unit 63 to the first settlement server 5A (step S144), and terminates the process.

<Conclusion>

A settlement system according to the present embodiment having the above configuration is provided with: the sales server 3 for selling a commodity; the settlement server 5 (first settlement server 5A and second settlement server 5B) for performing settlement processing pertaining to a commodity to be sold; and the user terminal device to be used by the user for performing operations related to purchase of a commodity. In a settlement system according to the present embodiment, information interchange between the sales server 3 and the settlement server 5 for settlement processing of a commodity is relayed by the user terminal device 1. For example, the settlement request relay unit 21 of the user terminal device 1 receives a settlement request pertaining to a purchased commodity from the sales server 3, and transmits the received settlement request to the settlement server 5 (first settlement server 5A). As another example, the settlement result relay unit 23 of the user terminal device 1 receives a settlement result, which is the result of settlement processing, from the settlement server 5 (first settlement server 5A), and transmits the received settlement result to the sales server 3. The sales server 3 and the settlement server 5 do not communicate directly with each other. Therefore, a settlement system according to the present embodiment can transmit and receive smoothly information to be used for settlement processing.

The sales server 3 and the first settlement server 5A have respectively code processing units 43 and 50b for encrypting and decoding information to be transmitted and received. The user terminal device 1 relays encrypted information but cannot decrypt or alter the information. It is therefore possible to enhance reliability of information which is transferred between the sales server 3 and the first settlement server 5A via the user terminal device 1.

It is to be noted that the technology herein is not limited to the above configuration wherein information to be transmitted and received between the sales server 3 and the first settlement server 5A is encrypted. The sales server 3 and the first settlement server 5A may attach an electronic signature to information to be transmitted. For example, the sales server 3 and the first settlement server 5 can convert information to be transmitted into digest data using a predetermined hash function, and encrypt the digest data using predetermined key information to prepare an electronic signature. When information with an electronic signature attached thereto is received, the sales server 3 and the first settlement server 5 decode the electronic signature so as to acquire digest data, and create digest data from the received information using the same hash function. The sales server 3 and the first settlement server 5 can judge that received information is valid when both digest data accord.

The user terminal device 1 has the non-contact communication unit 16 for performing non-contact communication with the IC card 7 which stores amount information such as electronic money or points to be used for purchasing a commodity. Settlement processing includes information interchange between the settlement server 5 and the IC card 7. The settlement mediation unit 22 of the user terminal device 1 mediates communication between the settlement server 5 and the IC card 7. In settlement processing, the settlement server 5 and the IC card 7 communicate with each other via the user terminal device 1, and the balance in the IC card 7 is decreased. It is therefore possible to implement convenient settlement processing which uses a storage medium, such as the IC card 7, having a non-contact communication function.

In a settlement system according to the present embodiment, the settlement server 5 is composed of two devices of the first settlement server 5A and the second settlement server 5B. The first settlement server 5A relays communication between the user terminal device 1 and the second settlement server 5B. The first settlement server 5A performs conversion processing of information to be transmitted and received between the sales server 3 and the second settlement server 5B, and conversion processing of information to be transmitted and received between the second settlement server 5B and the IC card 7. The second settlement server 5B communicates with the IC card 7 so as to perform settlement processing to subtract the amount of a sold commodity from the balance in the IC card 7. By providing such first settlement server 5A and second settlement server 5B, it is possible to adapt easily settlement processing of the second settlement server 5B to, for example, a plurality of types of sales servers 3 having different configurations or a plurality of types of IC cards 7 having different protocols or the like. It is possible to adapt easily one of the sales server 3 and the second settlement server 5B to a change in specifications of the other.

In the sales server 3, the ID generating unit 42 generates a transaction ID for a series of processing such as sales processing and settlement processing of a purchased commodity. The sales server 3 attaches the generated transaction ID to a settlement request, and transmits the settlement request via the user terminal device 1 to the first settlement server 5A. The first settlement server 5A stores the history of the state of settlement processing or the like in the storage unit 51 as the settlement history information 51a in association with the transaction ID related to the received settlement request. It is to be noted that the first settlement server 5A stores history related to sales processing, settlement processing or the like in the settlement history information 51a even when the processing is terminated before completion due to a malfunction or the like. The malfunction confirmation unit 44 of the sales server 3 therefore can confirm existence/nonexistence of a malfunction on the basis of the transaction ID and the settlement history information 51a when a malfunction or the like occurs in communication and settlement processing is suspended. The malfunction determination unit 50c of the first settlement server 5A can specify the malfunction occurrence point in process steps of settlement processing on the basis of the settlement state of the settlement history information 51a.

The sales server 3 stores the history of settlement processing in the storage unit 31 as the sales history information 31a. A transaction ID, the user ID of a user who uses the user terminal device 1, the result of settlement processing and the like are stored in association with the sales history information 31a. The sales server 3 therefore can determine easily whether completion of settlement processing of a commodity to be sold is to be confirmed with the settlement server 5 or not. The sales server 3 can notify the user terminal device 1 of the fact that processing, for which settlement processing has not been completed, exists. The user terminal device 1 therefore can notify the user by, for example, displaying at the display unit 13 a message indicating that incomplete processing exists. Notification by the user terminal device 1 can be achieved when, for example, the user performs log-in processing to the sales server 3 at the user terminal device 1. The user terminal device 1 makes a notice at least before the next settlement processing is started. It is therefore possible to report the fact that processing has been suspended due to a malfunction in communication or the like to the user, and it is possible to allow the user to select whether the process is to be restarted or not.

The storage unit 73 of the IC card 7 stores the history of changes in the balance of electric money, points or the like as the balance history information 73b. The first settlement server 5A stores correspondence between an update ID related to update processing of the balance in the IC card 7 and a transaction ID pertaining to settlement processing in the settlement history information 51a. The malfunction determination unit 50c of the first settlement server 5A compares the balance history information 73b acquired from the IC card 7 with the settlement history information 51a stored in the storage unit 51. The malfunction determination unit 50c determines whether a malfunction has occurred in update processing of the balance in the IC card 7 or not. It is therefore possible to determine precisely whether writing in the IC card 7 in settlement processing has been completed or not.

When it is determined that a malfunction has occurred in settlement processing, the sales server 3 performs processing to restart the suspended processing. At this time, the sales server 3 restarts the process by a method corresponding to the state of settlement processing, such as Not Requested, Settlement Not Reached, Process Not Completed or Settlement Reached, confirmed by the settlement server 5 via the user terminal device 1. That is, the sales server 3 restarts the process from the suspended point in the process steps of settlement processing. A settlement system according to the present embodiment therefore can complete reliably settlement processing related to a commodity to be sold.

It is to be noted that the technology herein is not limited to the configuration of the present embodiment wherein the sales server 3 is constituted as one device. The sales server 3 may be composed of two or more devices. Although the settlement server 5 is composed of two devices of the first settlement server 5A and the second settlement server 5B, the technology herein is not limited to this. The functions of the first settlement server 5A and the second settlement server 5B may be integrated into one settlement server 5. The settlement server 5 may be composed of three or more devices. Although the above user terminal device 1 is provided with the non-contact communication unit 16 for performing non-contact communication with the IC card 7, the technology herein is not limited to this. The user terminal device 1 may not be provided with the non-contact communication unit 16 but be connected wiredly or wirelessly with an external device having a non-contact communication function. Although the above IC card 7 functions as a storage medium for storing amount information, a storage medium is not limited to card type but may be any one of various forms.

Although the second settlement server 5B generates an update ID in a settlement system according to the present embodiment, the technology herein is not limited to this. The first settlement server 5A may generate an update ID and notify the second settlement server 5B of the generated update ID. Although the first settlement server 5A decodes an encrypted settlement request when receiving the settlement request from the sales server 3 via the user terminal device 1, the technology herein is not limited to this. The first settlement server 5A may transmit the received settlement request to the second settlement server 5B without decoding the settlement request. In such a case, the second settlement server 5B may decode a settlement request and transmit necessary information in decoded information to the first settlement server 5A. As is the case with information transmitted and received between the sales server 3 and the first settlement server 5A via the user terminal device, information transmitted and received between the first settlement server 5A and the second settlement server 5B may be encrypted, or transmitted and received with an electronic signature attached thereto.

The technology herein is not limited to the above configuration wherein electronic money, points or the like charged in the IC card 7 is used for payment of the price of a purchased commodity. For example, a credit card may be used for payment by causing the user to enter identification information of the credit card or the like in payment processing at the user terminal device 1. Moreover, amount information of electronic money, points or the like may be stored in the user terminal device 1, and a storage medium such as the IC card 7 is not used in such a case. The present embodiment is only an example, wherein the process is restarted after determining which of four states of Not Requested, Settlement Not Reached, Process Not Completed and Settlement Reached the state of settlement processing is. The state of settlement processing may be determined using three or less states, or using five or more states, and may also be determined using four states different from the four states described above.

The process procedures or the like of the user terminal device 1, the sales server 3, the first settlement server 5A and the second settlement server 5B described in the present embodiment is only an example, and the technology herein is not limited to this. The configuration of the balance history information 73b illustrated in FIG. 4, the sales history information 31a illustrated in FIG. 6, and the settlement history information 51a illustrated in FIG. 8 is only an example, and the technology herein is not limited to this. The device configuration of a settlement system and how to share functions in the respective devices are not limited to ones described in the present embodiment. For example, at least a part of the function of the above user terminal device 1 in the present embodiment may belong to the settlement server 3 or the settlement server 5. On the contrary, at least a part of the function of the above sales server 3 or settlement server 5 may belong to the user terminal device 1.

In the technology herein, the user terminal device relays transmission and reception of information between the sales server and the settlement server. It therefore becomes possible to transmit and receive smoothly information to be used for settlement processing.

When used in the present specification, each element or the like denoted in a singular form with a word “a” or “an” attached in front thereof is to be understood not to eliminate the possibility of a plurality of elements related thereto.

What is claimed is:

1. A settlement system comprising:
a sales server for performing sales processing pertaining to sales of a commodity;
a settlement server for performing settlement processing pertaining to a commodity which is sold by the sales server in the sales processing; and
a user terminal device having a communication unit, which communicates with the sales server and with the settlement server via a network, and an operation acceptance unit configured to accept operation pertaining to purchase of the commodity,
wherein the user terminal device has:
a settlement request relay unit configured to receive a settlement request pertaining to a commodity, for which operation pertaining to purchase is accepted by the operation acceptance unit, from the sales server and transmit the received settlement request to the settlement server; and
a settlement information relay unit configured to receive settlement information pertaining to a result of the settlement processing from the settlement server and transmit the received settlement information to the sales server.

2. The settlement system according to claim 1, wherein
each of the sales server and the settlement server has a conversion unit configured to convert the settlement request and the settlement information into unalterable information, and
the user terminal device cannot alter the settlement request and the settlement information obtained from conversion by the conversion unit.

3. The settlement system according to claim 1, wherein
the sales server encrypts the settlement request or attaches an electronic signature to the settlement request before transmitting the settlement request to the user terminal device, and
the settlement server encrypts the settlement information or attaches an electronic signature to the settlement information before transmitting the settlement information to the user terminal device.

4. The settlement system according to claim 1, wherein the sales server and the settlement server do not communicate directly with each other.

5. The settlement system according to claim 1, wherein the user terminal device has:
a non-contact communication unit configured to perform non-contact communication with a storage medium for storing amount information; and
a settlement mediation unit configured to mediate communication pertaining to settlement processing between the settlement server and the storage medium.

6. The settlement system according to claim 5, wherein an amount pertaining to amount information stored in the storage medium is reduced in the settlement processing.

7. The settlement system according to claim 1, wherein
the sales server has a generation unit configured to generate identification information pertaining to purchase and settlement of a commodity, and is configured to transmit identification information generated by the generation unit together with the settlement request to the user terminal device, and
the settlement server has a storage unit configured to store processing status information pertaining to settlement processing in association with identification information related to a settlement request received from the user terminal device.

8. The settlement system according to claim 7, wherein the sales server has a malfunction confirmation unit configured to confirm existence or nonexistence of a malfunction related to settlement processing with the settlement server via the user terminal device on the basis of the identification information.

9. The settlement system according to claim 7, wherein the settlement server has a malfunction determination unit configured to determine a malfunction occurrence point in processing steps of settlement processing on the basis of processing status information stored in the storage unit.

10. The settlement system according to claim 1, wherein
the commodity is a digital content, and
the user terminal device performs processing to acquire the digital content and utilize the acquired digital content.

11. The settlement system according to claim 1, wherein
the settlement server includes two servers,
one server relays communication between the user terminal device and the other server, and
the other server performs the settlement processing.

12. The settlement system according to claim 11, wherein the one server stores history information pertaining to settlement processing.

13. A settlement system comprising:
a sales server for performing sales processing pertaining to sales of a commodity;
a settlement server for performing settlement processing pertaining to a commodity which is sold by the sales server in the sales processing;
a user terminal device having a communication unit, which communicates with the sales server and with the settlement server via a network, a non-contact communication unit, which performs non-contact communication with a storage medium storing amount information, and an operation acceptance unit configured to accept operation pertaining to purchase of the commodity;
a storage unit configured to store processing status information pertaining to the settlement processing in association with identification information related to the settlement processing; and
a malfunction confirmation unit configured to confirm existence or nonexistence of a malfunction pertaining to settlement processing on the basis of the identification information and the processing status information.

14. The settlement system according to claim 13, wherein the storage unit holds the processing status information even when the sales processing or the settlement processing is terminated before completion.

15. The settlement system according to claim 13, wherein the sales server stores correspondence between identification information related to the settlement processing and user identification information related to a user of the user terminal device.

16. The settlement system according to claim 13, wherein the sales server stores a result of the settlement processing in association with identification information related to the settlement processing.

17. The settlement system according to claim 13, wherein the user terminal device notifies a user of the user terminal device of a malfunction pertaining to settlement processing.

18. The settlement system according to claim 17, wherein the user terminal device makes a notice pertaining to a malfunction to a user of the user terminal device when log-in processing to the sales server is performed.

19. The settlement system according to claim 17, wherein the user terminal device makes a notice pertaining to a malfunction to a user of the user terminal device after a malfunction occurs in settlement processing and at least before next settlement processing is started.

20. The settlement system according to claim 17, further comprising a restart unit configured to restart settlement processing, in which a malfunction occurred, after the user terminal device makes a notice pertaining to a malfunction.

21. The settlement system according to claim 13, further comprising a restart unit configured to restart settlement processing, in which a malfunction occurred, when the malfunction confirmation unit confirms existence of a malfunction.

22. The settlement system according to claim 13, further comprising a malfunction determination unit configured to determine a malfunction occurrence point in processing steps of settlement processing on the basis of identification information related to the settlement processing and processing status information stored in the storage unit.

23. The settlement system according to claim 22, further comprising a restart unit configured to restart settlement processing from a point, which has been determined by the malfunction determination unit, when the malfunction confirmation unit confirms existence of a malfunction.

24. The settlement system according to claim 13, wherein the sales server has a generation unit configured to generate identification information to be related to the settlement processing.

25. The settlement system according to claim 13, wherein
the storage medium stores history information of stored amount information, and
the sales server has an update determination unit configured to determine existence or existence of a malfunction pertaining to update processing of amount information stored in the storage medium on the basis of history information acquired from the storage medium.

26. The settlement system according to claim 25, wherein
the storage medium stores a change in amount information in association with identification information related to the update processing, and
the settlement server stores correspondence between identification information related to the update processing and identification information related to the settlement processing.

27. A settlement system comprising:
a user terminal device having a non-contact communication unit configured to perform non-contact communication with a storage medium storing amount information and history information of the amount information; and
a settlement server having an update processing unit configured to communicate with the user terminal device and update amount information stored in the storage medium, and an update determination unit configured to determine existence or nonexistence of a malfunction pertaining to processing by the update processing unit on the basis of history of processing by the update processing unit and history information acquired from the storage medium.

28. The settlement system according to claim 27, wherein the update determination unit determines a content of a malfunction when a malfunction exists.

29. The settlement system according to claim 1, wherein the user terminal device is a non-face-to-face device.

30. The settlement system according to claim 13, wherein the user terminal device is a non-face-to-face device.

31. The settlement system according to claim 27, wherein the user terminal device is a non-face-to-face device.

32. A user terminal device comprising:
a communication unit configured to communicate with two servers for performing processing of sales of a commodity and settlement pertaining to a commodity to be sold;
an operation acceptance unit configured to accept operation pertaining to purchase of the commodity;
a settlement request relay unit configured to receive a settlement request pertaining to a commodity, for which operation pertaining to purchase is accepted by the operation acceptance unit, from one server and transmit the received settlement request to the other server; and
a settlement information relay unit configured to receive settlement information pertaining to a result of settlement processing from the other server and transmit the received settlement information to the one server.

33. A sales server, which is provided with a communication unit configured to communicate with a user terminal device and performs sales processing pertaining to sales of a commodity, comprising:
a purchase request reception unit configured to receive a purchase request of a commodity from the user terminal device;
a settlement request transmission unit configured to transmit a settlement request pertaining to a commodity to the user terminal device in response to a purchase request received at the purchase request reception unit; and
a settlement information reception unit configured to receive settlement information pertaining to a result of settlement processing for a settlement request, which has been transmitted from the settlement request transmission unit, from the user terminal device.

34. A sales server, which is provided with a communication unit configured to communicate with a user terminal device and performs sales processing pertaining to sales of a commodity, comprising:
a storage unit configured to store processing status information pertaining to settlement processing in association with identification information related to the settlement processing pertaining to a commodity to be sold in the sales processing; and
a malfunction confirmation unit configured to confirm existence or nonexistence of a malfunction pertaining to settlement processing on the basis of the identification information and the processing status information.

35. A settlement server, which is provided with a communication unit configured to communicate with a user terminal device and performs settlement processing pertaining to settlement of a commodity, comprising:
a settlement request reception unit configured to receive a settlement request pertaining to a commodity from the user terminal device;
a settlement processing unit configured to perform settlement processing in response to a settlement request received by the settlement request reception unit; and
a settlement information transmission unit configured to transmit settlement information pertaining to a result of settlement processing by the settlement processing unit to the user terminal device.

36. A settlement server, which is provided with a communication unit configured to communicate with a user terminal device and performs settlement processing pertaining to settlement of a commodity, comprising:
a storage unit configured to store processing status information pertaining to the settlement processing in association with identification information related to the settlement processing; and
a malfunction determination unit configured to determine a malfunction occurrence point in processing steps of settlement processing on the basis of identification information related to the settlement processing and processing status information stored in the storage unit.

37. A non-transitory recording medium in which a computer program is recorded, the computer program being capable of causing a computer, which is provided with a communication unit configured to communicate with two servers for performing processing of sales of a commodity and settlement pertaining to a commodity to be sold, to operate as:
a settlement request relay unit configured to receive a settlement request pertaining to a commodity, for which operation pertaining to purchase has been accepted, from one server and transmit the received settlement request to the other server; and
a settlement information relay unit configured to receive settlement information pertaining to a result of settlement processing from the other server and transmit the received settlement information to the one server.

38. A non-transitory recording medium in which a server program is recorded, the server program being capable of causing a sales server, which is provided with a communication unit configured to communicate with a user terminal device and performs sales processing pertaining to sales of a commodity, to operate as:
a storage processing unit configured to perform processing to store processing status information pertaining to settlement processing in association with identification information related to settlement processing pertaining to a commodity to be sold in the sales processing; and
a malfunction confirmation unit configured to confirm existence or nonexistence of a malfunction pertaining to settlement processing on the basis of the identification information and the processing status information.

39. A non-transitory recording medium in which a server program is recorded, the server program being capable of causing a settlement server, which is provided with a communication unit configured to communicate with a user terminal device and performs settlement processing pertaining to sales of a commodity, to operate as:
a storage processing unit configured to perform processing to store processing status information pertaining to the settlement processing in association with identification information related to the settlement processing; and
a malfunction determination unit configured to determine a malfunction occurrence point in processing steps of settlement processing on the basis of identification information related to the settlement processing and processing status information stored in the storage unit.
